(19) United States
(12) Patent Application Publication
(10) Pub. No.: US 2025/0080508 A1
(43) Pub. Date: Mar. 6, 2025

(54) Computing Systems and Devices with Cryptographic Agility

(71) Applicant: Google LLC, Mountain View, CA (US)

(72) Inventors: Omer Berkman, Tel Aviv (IL); Marcel M.M. Yung, New York, NY (US)

(21) Appl. No.: 18/440,539

(22) Filed: Feb. 13, 2024

Related U.S. Application Data
(60) Provisional application No. 63/494,531, filed on Apr. 6, 2023.

(51) Int. Cl. H04L 9/40; H04L 9/14; H04L 9/32

(52) U.S. Cl. CPC H04L 63/0428; H04L 9/14; H04L 9/3242

(57) ABSTRACT

Provided are computer systems which demonstrate improved cryptographic agility via inclusion of multiple cryptographic operating modes. In one example, one or more devices included within a computing system are designed to include multiple cryptographic operating modes from the outset (e.g., prior to deployment of the system, “by design”). Additionally or alternatively, one or more devices included within the computing system (e.g., a gateway computing device) can be updated to include the multiple cryptographic operating modes after deployment of the system (e.g., in an “ad hoc” fashion). A system can also include both device(s) that have multiple operating modes by design and device(s) that have multiple operating modes introduced in an ad hoc fashion. Inclusion of the multiple cryptographic operating modes can serve to enhance the security of at least the communications of the computing system that are performed by or follow the updated device(s).

### RELATED APPLICATIONS

This application claims priority to and the benefit of U.S. Provisional Patent Application No. 63/494,531, filed Apr. 6, 2023. U.S. Provisional Patent Application No. 63/494,531 is hereby incorporated by reference in its entirety.

### FIELD

The present disclosure relates generally to cryptographic approaches for computer systems. More particularly, the present disclosure relates to computer systems and associated communications protocols which provide improved cryptographic agility via inclusion of multiple cryptographic operating modes.

### BACKGROUND

A computer system can include a number of different computing devices that communicate with each other (e.g., directly or indirectly over any number of wired or wireless communications links). Communications between some or all of the different computing devices may be encrypted using one or more different cryptographic tools such as cryptographic protocols or encryption algorithms. One example class of cryptographic tools are those based on a Diffie-Hellman style key exchange. One example cryptographic protocol is the Transport Layer Security (TLS) protocol. In addition to protocols and encryption algorithms, other cryptographic tools include authentication, digital signature, proof of knowledge, and others.

When effective cryptographic tools are applied to encrypt communications between two computing devices, then other devices who observe (or even actively relay) the encrypted communications between the two computing devices are not able to ascertain the underlying data or information included in the encrypted communications.

### SUMMARY

Aspects and advantages of embodiments of the present disclosure will be set forth in part in the following description, or can be learned from the description, or can be learned through practice of the embodiments.

One example aspect of the present disclosure is directed to a gateway computing device configured to perform operations. The operations include sending to a receiver computing device a first communication, wherein the first communication comprises an identifier associated with a transmitter device, a one-way function of the identifier associated with the transmitter device, or a set of authentication data associated with the transmitter device. The operations include receiving from the receiver computing device a second communication that is responsive to the first communication, wherein the second communication comprises a set of cryptographic material. The operations include authenticating the set of cryptographic material using the set of authentication data. The operations include sending to the receiver computing device a third communication, wherein at least an encrypted portion of the third communication is encrypted using the set of cryptographic material.

Another example aspect of the present disclosure is directed to a computing device configured to transmit data. The computing device includes one or more processors and one or more non-transitory computer-readable media that store: a first set of cryptographic instructions for transmitting data according to a first cryptographic operating mode; a second set of cryptographic instructions for transmitting data according to a second cryptographic operating mode, wherein the second cryptographic operating mode has a different security profile than the first cryptographic operating mode; and instructions that, when executed by the one or more processors, cause the computing device to operationally switch from the first cryptographic operating mode to the second cryptographic operating mode.

Another example aspect of the present disclosure is directed to a computer-implemented method for providing improved Transport Layer Security (TLS) for communications between a first computing device and a second computing device. The method includes receiving, by a gateway computing device, one or more first communications from the first computing device, wherein the one or more first communications are structured according to a TLS protocol and include a payload and a client finished portion. The method includes using, by the gateway computing device, the client finished portion of the one or more first communications as authentication data to establish an encrypted communication session with the second computing device. The method includes transmitting, by the gateway computing device, at least the payload from the one or more first communications to the second computing device in the encrypted communication session.

Another example aspect of the present disclosure is directed to a gateway computing device configured to provide improved security for communications between a first computing device and a second computing device. The gateway computing device is configured to perform operations. The operations include receiving, by the gateway computing device from the first computing device, one or more sets of first encrypted data intended for the second computing device, wherein the one or more sets of first encrypted data are structured according to a secure message transmission protocol and have been encrypted by the first computing device according to a first set of cryptographic key material established for a first encrypted communications session defined between the first computing device and the second computing device. The operations include engaging, by the gateway computing device, in one or more key exchange communications with the second computing device, wherein the one or more key exchange communications are structured according to the secure message transmission protocol and establish a second set of cryptographic key material for a second encrypted communications session defined between the gateway computing device and the second computing device. The operations include further encrypting, by the gateway computing device, the one or more sets of first encrypted data using the second set of cryptographic key material established for the second encrypted communications session to generate one or more sets of second encrypted data. The operations include transmitting, by the gateway computing device, the one or more sets of second encrypted data to the second computing device.

Another example aspect of the present disclosure is directed to a method for modifying a cryptographic communication system comprising at least a first computing device, a second computing device, and a third computing device. The method includes detecting that at least the first computing device employs one or more first cryptographic tools that do not meet one or more security constraints, wherein the first computing device is incapable of being updated with new cryptographic tools that meet the one or more security constraints. The method includes, in response to detecting that at least the first computing device employs the one or more first cryptographic tools that do not meet the one or more security constraints: causing the second computing device to change from a first cryptographic operating mode to a second cryptographic operating mode. Operation of the second computing device in the second cryptographic operating mode includes the use, by the second computing device when communicating with the third computing device, of one or more second cryptographic tools that satisfy the one or more security constraints, whereby failure to meet the one or more security constraints is limited to communications between the first computing device and the second computing device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system with improved cryptographic agility according to example embodiments of the present disclosure.

FIG. 2A depicts a block diagram of an example computing system operating in an example first base cryptographic operating mode according to example embodiments of the present disclosure.

FIG. 2B depicts a block diagram of an example computing system operating in an example cryptographic operating mode in which the gateway computing device uses authentication data to obtain and use additional cryptographic key material according to example embodiments of the present disclosure.

FIG. 3 depicts a block diagram of an example computing system operating in an example cryptographic operating mode in which the transmitter computing device uses a second, different cryptographic algorithm according to example embodiments of the present disclosure.

FIG. 4 depicts a block diagram of an example computing system operating in an example cryptographic operating mode in which the transmitter computing device performs multiple rounds of encryption according to example embodiments of the present disclosure.

FIG. 5 depicts a block diagram of an example computing system operating in an example cryptographic operating mode in which the transmitter device advertises additional, stronger authentication data according to example embodiments of the present disclosure.

FIG. 6 depicts a block diagram of an example computing system operating in an example cryptographic operating mode in which the transmitter computing device advertises stronger authentication data which is also used as identifier for the transmitter computing device according to example embodiments of the present disclosure.

FIG. 7 depicts a block diagram of an example computing system operating in an example second base cryptographic operating mode according to example embodiments of the present disclosure.

FIG. 8 depicts a block diagram of an example computing system operating in an example cryptographic operating mode in which the gateway computing device uses authentication data to obtain and use additional cryptographic key material according to example embodiments of the present disclosure.

FIG. 9 depicts a block diagram of an example computing system operating in an example cryptographic operating mode in which a transmitter computing device uses a second, different cryptographic algorithm according to example embodiments of the present disclosure.

FIG. 10 depicts a block diagram of an example computing system operating in an example cryptographic operating mode in which a symmetric cryptographic key is used according to example embodiments of the present disclosure.

FIG. 11 depicts a block diagram of an example computing system operating in an example cryptographic operating mode in which the transmitter computing device uses a stronger elliptic curve group to generate a public key according to example embodiments of the present disclosure.

FIG. 12A depicts a block diagram of an example computing system operating in an example third base cryptographic operating mode according to example embodiments of the present disclosure.

FIG. 12B depicts a block diagram of an example computing system operating in an example cryptographic operating mode in which a client finished portion of a Transport Layer Security (TLS) communication is used as authentication data according to example embodiments of the present disclosure.

FIG. 13A depicts an alternative block diagram of an example computing system operating in the example third base cryptographic operating mode according to example embodiments of the present disclosure.

FIG. 13B depicts a block diagram of an example computing system operating in an example cryptographic operating mode in which the gateway computing system initiates a second secure communication session which encapsulates a first secure communication session according to example embodiments of the present disclosure.

FIG. 14 depicts a block diagram of an example computing system according to example embodiments of the present disclosure.

### DETAILED DESCRIPTION

Generally, the present disclosure is directed to computer systems and associated communications protocols which demonstrate improved cryptographic agility via inclusion of multiple cryptographic operating modes. The inclusion of and ability to operate within multiple cryptographic operating modes can be referred to as “cryptographic agility”, and can serve to “future-proof” the device or system against future developments in cryptographic counter-measures and/or respond to vulnerabilities introduced by developments in cryptographic counter-measures. In particular, in some implementations, one or more devices included within a computing system are designed to include multiple cryptographic operating modes from the outset (e.g., prior to deployment of the system, “by design”). In other implementations, one or more devices included within the computing system can be updated to include the multiple cryptographic operating modes after deployment of the system (e.g., in an “ad hoc” fashion). In yet further implementations, a system can include both device(s) that have multiple operating modes by design and device(s) that have multiple operating modes introduced in an ad hoc fashion. Inclusion of the multiple cryptographic operating modes can serve to enhance the security of at least the communications of the computing system that are performed by or follow the updated device(s). The proposed techniques can be particularly beneficial when applied to systems that include other devices that are incapable of being updated or that are otherwise difficult to update after deployment of the other devices into an operational setting.

More particularly, one technical problem in the field of computer security is that the effectiveness of existing cryptographic techniques typically degrades over time. This degradation in effectiveness can be due to a combination of a number of different factors, including, for example, due to mistakes in software update implementation, due to attackers using more powerful hardware and/or more sophisticated attacks, due to advances in cryptographic counter-measures (which can also be referred to as “cryptanalysis”), and/or factors. Thus, a system which currently demonstrates sufficient cryptographic security against attacks may lose its effectiveness as cryptographic counter-measures advance. This technical problem is particularly acute for devices or systems that are incapable of being updated or that are otherwise difficult to update after deployment. Specifically, these systems or devices are not able to receive updated software or hardware which could maintain the security of these systems or devices over time.

The present disclosure provides a technical solution to this problem by proposing systems or devices that include (e.g., at the time of deployment and/or after deployment) capability to perform multiple different cryptographic techniques. More particularly, according to one example, one or more devices included in a computing system can be capable of operating in one or more of multiple different cryptographic operating modes. Then, when security vulnerabilities arise over time, these computing device(s) can alter (e.g., either automatically or in response to instructions from an authority) their operating mode so as to operate in a different, potentially more secure cryptographic operating mode. In such fashion, computer devices and systems can be built with agility in mind, enabling the devices and systems to adapt over time to changing security conditions.

In another example, one or more devices included in a computing system can be capable of operating in a certain cryptographic operating mode. Then, when security vulnerabilities arise over time, at least one of these computing device(s) can be updated (e.g., in an “ad hoc” fashion) so as to enable the device(s) to operate in a different, potentially more secure cryptographic operating mode. In such fashion, cryptographic agility can be added or introduced after deployment of the system, enabling the devices and systems to adapt over time to changing security conditions. The added cryptographic operating modes can include two or more devices in the computing system to create a more secure communications channel between the two or more devices.

As one example application of the approach described above, a cryptographic communication system can include at least a first computing device, a second computing device, and a third computing device. During operation of the system, it can be detected that at least the first computing device employs one or more first cryptographic tools that do not (or no longer) meet one or more security constraints. However, the first computing device may be incapable of being updated with new cryptographic tools that meet the one or more security constraints. Therefore, according to an aspect of the present disclosure, in response to detecting that at least the first computing device employs the one or more first cryptographic tools that do not meet the one or more security constraints: the cryptographic communication system can be altered so that the second computing device changes from a first cryptographic operating mode to a second cryptographic operating mode. Operation of the second computing device in the second cryptographic operating mode can include the use, by the second computing device when communicating with the third computing device, of one or more second cryptographic tools that satisfy the one or more security constraints. In such a manner, the failure to meet the one or more security constraints can be isolated to communications between the first computing device and the second computing device. For example, communication between the first computing device and the second computing device may be subject to fewer attacks for various reasons (e.g., the communication requires geographic proximity) and therefore limiting the vulnerability to this specific link in the communication chain may significantly decrease the security vulnerability of the system as a whole.

The proposed approaches provide a number of technical benefits. As one example, the proposed approaches can improve the security of a system or device against malicious actors. For example, by adjusting the cryptographic operating mode of the system or device to account for changes in the security setting in which a system or device is deployed, the system or device can proactively respond to and/or avoid attacks on the security of the system or device. As another example technical benefit, the proposed approach can enable systems and devices to have a longer service life, as such systems and devices will need to be updated for a fewer number of instances. This increase in service life can result in reduced system maintenance. Thus, the proposed approach can improve the efficiency, lifespan, and effectiveness of a computing system or device.

With reference now to the Figures, example embodiments of the present disclosure will be discussed in further detail.

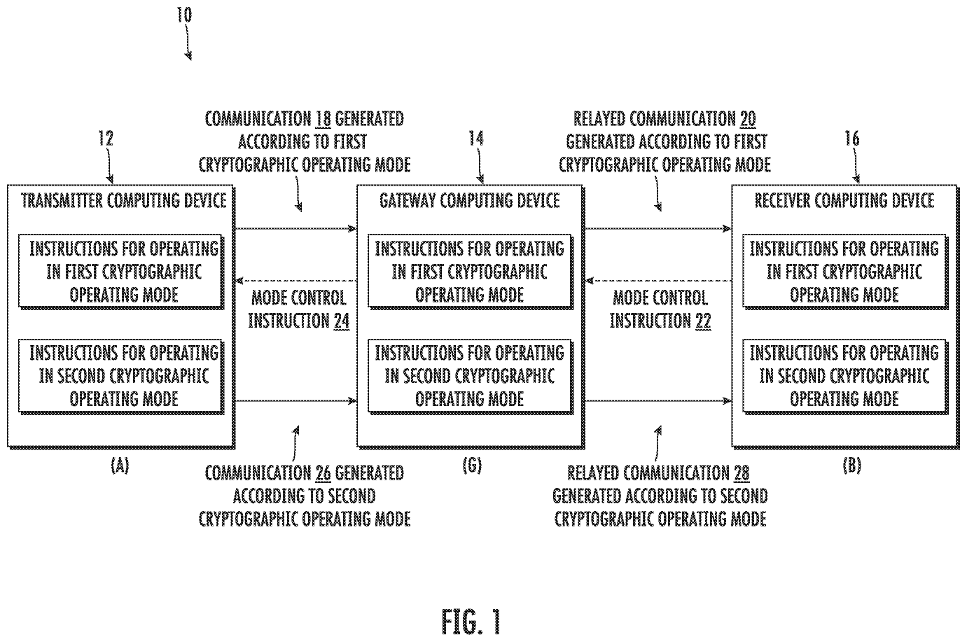

FIG. 1 depicts a block diagram of an example computing system 10 with improved cryptographic agility according to example embodiments of the present disclosure. The system 10 can include a transmitter computing device 12, a gateway computing device 14, and a receiver computing device 16. The transmitter computing device 12 can, potentially among other functionalities, operate to transmit communications that contain information that is ultimately intended for the receiver computing device 16. The gateway computing device 14 can operate to receive the communications from the transmitter computing device 12 and to relay the communications to the receiver computing device 16, and vice versa.

Although the device 12 is referred to as a “transmitter device,” the functionality of the transmitter device 12 is not necessarily limited to only transmitting data. In some implementations, the device 12 may have various additional communications capabilities, such as two-way communications capabilities (e.g., able to both transmit and also receive and process incoming communications). However, various implementations of the present disclosure do provide benefits in situations in which the transmitter device 12 has limited capabilities, such as a limited ability to be updated. More generally, in some implementations, all communications between the devices of FIG. 1 (that is, device 12 with device 14, and device 14 with device 16) may be two-way communications.

The term “communication” generally refers to any type or manner of data that is transmitted between two computing devices. The term “communications data” can refer to data that is included in a communication. A communication can be transmitted via any type of hardware or components such as any number of wired or wireless connections. In general, the set of components that facilitates communications between a pair of computing devices can be referred to as a communications link. A series of communications links can form a communications chain. Communications can be transmitted directly between devices or indirectly using a number of intermediary devices. A communication can be structured according to any number of different communications protocols. A communications protocol can define the structure, order, and/or process by which two devices send communications to each other. A series of one or more communications between devices can occur in a particular communications session.

Each of the transmitter computing device 12, the gateway computing device 14, and the receiver computing device 16 can be any different type of computing device, such as an Internet of Things (IoT) device, a user device (e.g., smartphone, tablet, etc.), a server computing device, etc. In some examples, the transmitter computing device 12 is a beacon computing device or other low-power device such as an embedded device or an IoT device, the gateway computing device 14 is a user device such as a smartphone, and the receiver computing device 16 is a server computing device. In some of these examples, the beacon computing device or other low-power device such as an embedded device or an IoT device may be incapable of being updated or otherwise difficult to update.

According to an aspect of the present disclosure, one or more (e.g., some or all) of the transmitter computing device 12, the gateway computing device 14, and the receiver computing device 16 can include instructions for operating in multiple different cryptographic operating modes. In some implementations, these instructions for operating in multiple different cryptographic operating modes can be included in the device(s) at the outset (e.g., “by design”). In other implementations, instructions for operating in multiple different cryptographic operating modes can be added to the devices (e.g., in an “ad hoc” fashion) after deployment of the system. In yet other implementations, a system can include both device(s) that include multiple operating modes by design and device(s) that have been updated in an ad hoc fashion to include multiple operating modes.

As an example, as illustrated in FIG. 1, each of the transmitter computing device 12, the gateway computing device 14, and the receiver computing device 16 includes two respective sets of instructions for operating in a first cryptographic operating mode and a second cryptographic operating mode. Although two modes are shown, instructions for any number of modes can be included or used.

In some implementations, as shown in FIG. 1, all of the devices 12, 14, and 16 can include instructions for both the first and second cryptographic operating modes. For example, these instructions can be included in the devices at the outset (e.g., prior to deployment of the system 10) so as to provide “agility by design”. However, although all devices are shown in FIG. 1 as having the instructions for both the first and second cryptographic operating modes, in other implementations only some but not all of the devices have instructions for operating in multiple cryptographic operating modes. For example, in some implementations, the device 12 may include only instructions for operating in the first cryptographic operating mode, while the devices 14 and 16 may include instructions for operating in both the first and second cryptographic operating modes. For example, the instructions for operating in the second cryptographic operating mode may be added to the devices 14 and 16 (e.g., but not 12) after deployment of the system 10 (e.g., to update the system 10 and provide cryptographic agility in an “ad hoc” fashion).

According to another aspect of the present disclosure, one or more (e.g., some or all) of the transmitter computing device 12, the gateway computing device 14, and the receiver computing device 16 can be operable to operationally switch between the different cryptographic operating modes (e.g., from the first cryptographic operating mode to the second cryptographic operating mode, and vice versa).

The transmitter computing device 12, the gateway computing device 14, and/or the receiver computing device 16 can be configured to operationally switch between cryptographic operating modes according to different switching logic and/or triggers. As one example, the transmitter computing device 12, the gateway computing device 14, and/or the receiver computing device 16 can be configured to automatically and periodically switch from the first cryptographic operating mode to the second cryptographic operating mode and vice versa. As another example, the transmitter computing device 12, the gateway computing device 14, and/or the receiver computing device 16 can be configured to configured to switch from the first cryptographic operating mode to the second cryptographic operating mode and vice versa in response to receipt of a mode control instruction from an authority. For example, in some implementations, the receiver computing device 16 and/or the gateway computing device 14 can be authorities relative to the transmitter computing device 12. In other implementations, the device 12 is not able to switch operating modes and only the devices 14 and 16 switch between operating modes.

Thus, in one example illustrated in FIG. 1, the transmitter computing device 12 can transmit a communication 18 generated according to the first cryptographic operating mode. The gateway computing device 14 can receive the communication 18 and generate a relayed communication 20 generated according to the first cryptographic operating mode. The gateway computing device 14 can transmit the relayed communication 20 to the receiver computing device 16. In some implementations, the gateway computing device 14 can perform further cryptographic operations on the communication 18 to generate the relayed communication 20. For example, in some implementations, the gateway computing device 14 can further encrypt the communication 18 using an additional key received from the receiver computing device 16. Thus, the term “relayed” does not necessarily indicate that the communication 18 is passed along without modification (although this is possible). Instead, the term “relayed” simply indicates that the gateway computing device 14 is operating to facilitate further exchange of information from the transmitter device 12 to the receiver computing device 16 and/or vice versa.

The receiver computing device 16 can generate a mode control instruction 22 and transmit the mode control instruction 22 to the gateway computing device 14. The mode control instruction 22 may be signed by the receiver computing device 16 using a signing certificate or key to prove the authority of the receiver computing device 16. The mode control instruction 22 may be intended for the gateway computing device 14 and/or the transmitter computing device 12. In some implementations, the gateway computing device 14 can send a mode control instruction 24 to the transmitter computing device 12. The mode control instruction 24 can be the same as (e.g., a relayed version of) the mode control instruction 22 or can be a different instruction generated sua sponte by the gateway computing device 14. In one example, the mode control instruction 22 can be used to generate the mode control instruction 24. For example, the instruction 22 can be used as a parameter (perhaps alongside other parameters) to a function implemented by the gateway computing device 14 to generate the instruction 24.

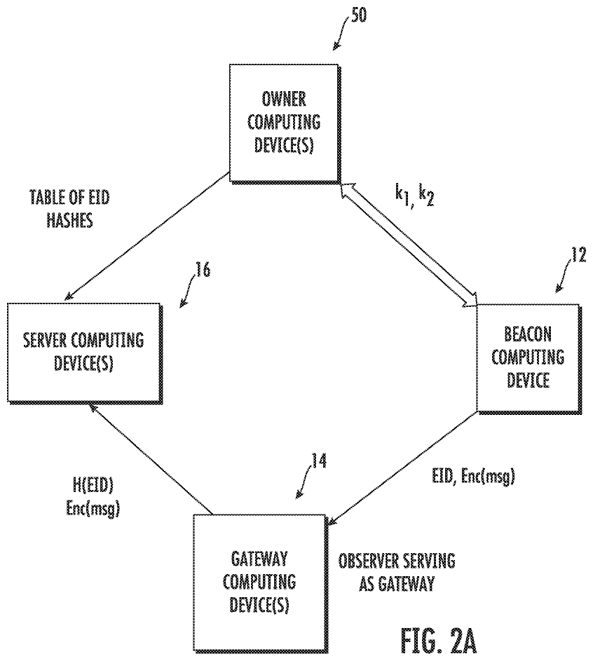

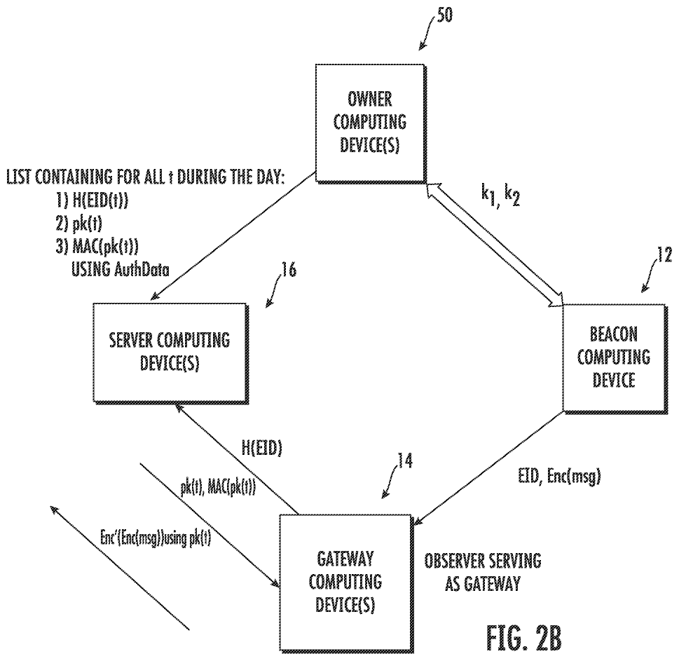

The mode control instructions 22 and/or 24 can cause the transmitter computing device 12, the gateway computing device 14, and/or the receiver computing device 16 to switch from the first cryptographic operating mode to the second cryptographic operating mode or vice versa. As examples, the first and second cryptographic operating modes can correspond to any combination of two or more of any of the operating modes shown in FIGS. 2A-13, or can include other operating modes as well. The mode control instructions 22 and/or 24 can be triggered by or generated or transmitted in response to a number of different logic or triggers. As examples, the mode control instructions 22 and/or 24 can be triggered by or generated or transmitted in response to: a failure of a software update to occur or succeed; user instructions; a detected threat or attack to the system 10; periodic triggers; and/or other triggers. More generally, any of the triggers described above can be referred to as a failure to satisfy one or more security constraints.

In some implementations, as shown in FIG. 1, after switching to the second cryptographic operating mode, the transmitter computing device 12 can transmit a communication 26 generated according to the second cryptographic operating mode. The gateway computing device 14 can receive the communication 26 and generate a relayed communication 28 generated according to the second cryptographic operating mode. The gateway computing device 14 can transmit the relayed communication 28 to the receiver computing device 16. In other implementations, communications from device 12 may remain structured according to the first cryptographic operating mode, while communications between device 14 and device 16 may switch to being generated according to the second cryptographic operating mode.

Thus, because system 10 includes the capability of operating in multiple different cryptographic operating modes, the system 10 may experience reduced security degradation resulting from the inability to update system components. Specifically, because multiple different components in the communications chain (e.g., such as the gateway computing device 14) are able to switch (e.g., “upgrade”) to a different operating mode, then security degradation related to specific components (e.g., the transmitter computing device 12) can be limited to only the immediate vicinity of these components even when the cryptographic operations provided by these components affect the system as a whole (beyond the vicinity). Therefore, the system 10 has system agility that is enabled by inclusion of components that may help each other even if a certain component cannot be updated.

To provide an example to illustrate this concept, assume for the sake of illustration that the transmitter computing device 12 is non-updateable. Denote the transmitter computing device 12 as A, the receiver computing device 16 by B, and the gateway computing device 14 as G. Assume for concreteness that A communicates with the B through the gateway G. Some example implementations of the present disclosure employ the following concept: The G-to-B link can be performed using cryptographic tools that provide stronger security than the tools used for the A-to-G link. This can limit any vulnerability associated with the inability of A to be updated to the link established between A and G.

One example approach that employs the general concept outlined above is as follows: A sends to G authentication data denoted AuthData that allows G to communicate securely with B. As demonstrated elsewhere herein, AuthData can be a public key whose secret part is known to B or can be a pseudorandom string that B can also generate. For example, AuthData may allow B to send to G authenticated cryptographic material which can be used by G to communicate securely with B.

Thus, in one example, if A sends a communication to B (through G) by encrypting the communications data using a cryptographic tool (e.g., encryption algorithm) whose strength becomes unsatisfactory, then the cryptographic material G receives from B as above allows G to further encrypt (and authenticate) the already encrypted communications data it receives from A using a stronger cryptographic algorithm. As a result, so long as there is no attack on the A-to-G communication link, then security is restored for the whole A-to-B communication link. Stated differently, the degradation in security attributable to device A being non-updatable can be limited to the A-to-G communication link, while the remainder of the communications chain can be secured.

Note that the solution described above is completely different from the traditional Middlebox-like system where the gateway acts as a man in the middle, decrypting and re-encrypting all communication on the A-to-B communication link. Instead, in the solution described above, G has no means of decrypting the A-to-B communication link. Instead, G encrypts (with a stronger cryptographic algorithm) the already encrypted data on the A-to-B communication link so that the data is doubly encrypted. Namely, G adds security without itself breaking or locally reducing security.

However, as described so far, the solution has a weakness. If A uses cryptographically weak algorithms, then AuthData may also be weak and, as a result, an attacker may be able to forge authentication of the new cryptographic material. Some example implementations tackle this issue as follows. G can set a short timeout and require that B send the authenticated cryptographic material before the timeout elapses. This forces an attacker to stage the attack in real time which is considerably harder.

Another possible solution to the challenge described above is to provide A with very strong AuthData as part of the system design. Even if A is unable to generate AuthData or use it during its normal operation, it may be able to store it and send it to G if an update is required.

More generally, since all systems have limitations and constraints, the actual possible solutions depend on the specific system. For example, the solution that is suggested just above of providing A with fixed AuthData that A can send G when needed is less appropriate if the data A sends must not enable linking different messages sent by A (which is indeed the requirement in two of the cases considered herein). Furthermore, systems may be designed so as to maximize their security within the system's constraints. Therefore, example systems described herein (e.g., system 10 of FIG. 1) incorporate additional security guarantees to be used in case future update is required. These additional security guarantees can be incorporated at the outset (e.g., “by design” and before or with the initial deployment of the system 10), or can be introduced after the system 10 as been deployed (e.g., although certain components such as device 12 may not be updatable, additional security guarantees can be introduced in an “ad hoc” fashion by updating the behavior of other devices such as device 14 or otherwise introducing new capabilities into the system 10).

The problem of non-updatable components can manifest itself in almost any system that requires security mechanisms. For concreteness, consider an example system where two entities A and B communicate with each other, and where A sends data to B and/or receives data from B through another entity G (e.g., G stands for gateway) and where G may not be fixed and is not necessarily known in advance. This example also does not assume that B and G have any a priori means for authenticating each other.

The above is a very general scenario which includes, for example, client-server communication on the World Wide Web (e.g., where the communication is not covered by both sides public key infrastructure (PKI)). Another example is where G is a gateway between networks (e.g., a smartphone-based Mobile Ad hoc Network, or MANET, or sensor networks), such as a component moving Bluetooth Low Energy (BLE) signals to IP packets, which is a service often implemented in the hardware protected portion of the device away from the user. The above scenarios have devices that may not be in contact with an updating authority.

The present disclosure proposes that a system (e.g., the system 10 shown in FIG. 1) can be designed from the start to support system update(s) and/or can be modified after deployment to provide cryptographic agility, even when some system element(s) cannot be updated post-deployment. Specifically, in the above scenario, the system can be designed in a way that mitigates much of the risk to the system as a whole from the inability of updating A.

Specifically, one example solution is to add the following to the different system components: Occasionally during A's normal operation or after receiving a suitable message from G, A sends an attestation of its version and other parameters. In addition to providing information of A's security status, A's attestation signifies that A is able to participate in the updating efforts (although A itself cannot be updated). If an update is not required G can ignore A's attestation. Otherwise G will either deliver A's attestation to B or act on the attestation by itself. Following A's attestation, G and/or B should be able to securely instruct A how to act in order to strengthen the system's security.

Note that the exact implementation details for how this last step is performed and of the update protocol depend heavily on each system's requirement and constraints. Possible solutions are described in the Figures that follow. However, some of the example systems are not initially designed to support an update if a component is non-updateable, while other example systems have agility by design so as to better support an update while still adhering to system constraints.

More particularly, some example settings in which the example techniques described herein can be applied are settings in which the transmitter computing device 12 is a beacon computing device 12. While the following FIGS. 2A-11 depict example cryptographic operating modes in this example context, the depicted cryptographic operating modes are not limited to this context and can more generally be applied to any set of computing devices such as the devices shown and discussed in FIG. 1.

As one example of the beacon computing device setting introduced above, FIG. 2A depicts a block diagram of an example computing system operating in an example first base cryptographic operating mode according to example embodiments of the present disclosure. In particular, FIG. 2A depicts an example crowdsource-based system which allows a beacon computing device 12 to send information (such as telemetric data) to the beacon's owner computing device 50 when the owner computing device 50 and the beacon computing device 12 are not in proximity to each other. To that end, the system depicted in FIG. 2A can operate as follows:

Initialization: Two symmetric cryptographic keys k1 and k2 are shared between the owner computing device 50 and the beacon computing device 12. As will be detailed below, the beacon computing device 12 uses k1 to generate an ephemeral ID (EID) that changes every few minutes so as not to be tracked, and uses k2 to encrypt its message. Denote the beacon's EID at time t by EID(t) (and recall that EID(t) depends on k1). Note, however, that the use of an ephemeral ID is not required; Alternative implementations of the present disclosure may use a static identifier.

Daily operation: Every day (or other suitable period) each owner computing device 50 sends to the receiver computing device 16 (e.g., which will hereafter be referred to as a server 16 for simplicity, but is not limited to being a server) a list containing H(EID(t)) for each time t, where H is a cryptographic hash function. Note that the use of a hash function is provided as an example. Other one-way functions could alternatively be used such as, for example, a key derivation function, a message authentication code function, or others. In addition, the use of a one-way function is not strictly necessary in other approaches in which the EID(t) is not used to generate the AuthData. The server computing device 16 generates a table from all owners' lists that maps each H(EID(t)) to the respective owner. The table can be referred to as the mapping table.

Normal operation: At time t, the beacon computing device 12 advertises EID(t) and the encrypted data. A nearby smartphone (or other device) acting as a gateway computing device 14 receives EID(t) and the encrypted data and forwards H(EID(t)) and the encrypted data to the server computing device 16 (e.g., this may be a form of a mobile ad-hoc network operation which is typically implemented in a layer away from the user and is automatically performed by the phone).

The server computing device 16, in turn, associates H(EID) with the beacon's owner computing device 50 using the mapping table. The server computing device 16 can now send the encrypted data to the owner computing device 50, or the owner computing device 50 can access the server computing device 16 and request its beacon's encrypted data. The owner computing device 50 can use key k2 to decrypt the encrypted data originally transmitted by the beacon computing device 12.

However, as described above, in some cases the beacon computing device 12 may be unable to be updated or difficult to update after deployment. This can result over time in degraded security of the encrypted message. For example, the encryption technique used to encrypt the message using key k1 may lose its effectiveness. In that case, the message may be susceptible to attack by an observing device.

In view of this challenge, aspects of the present disclosure provide an ad-hoc solution that provides agility in the face of non-updatable transmitter devices such as non-updatable beacon computing devices. As one example FIG. 2B depicts an ad hoc solution to non-updateable transmitter devices. In particular, FIG. 2B depicts a block diagram of an example computing system operating in an example cryptographic operating mode in which the gateway computing device 14 uses authentication data to obtain and use additional cryptographic key material according to example embodiments of the present disclosure.

In particular, as shown in FIG. 2B, the depicted system is able to use as authentication data (AuthData) a cryptographic function of the EID. This is enabled by the fact that the EIDs are pseudorandom and their values are known to the owner computing device 50. Indeed, this method is secure provided the EIDs are indeed pseudorandom and have sufficient length (e.g., 128 bits may be suitable).

More particularly, define AuthData(t) (the AuthData at time t), to be AuthData(t)=H(EID(t)∥“data”) where H is a cryptographic hash function and “data” represents some additional data. Using this particular function of EID(t) as the AuthData(t) is provided only as an example; the AuthData(t) can be generated in many different ways while retaining the benefits described herein. As one example, an alternative approach would be to define AuthData(t) (the AuthData at time t), to be AuthData(t)=KDF (EID(t)∥“data”) where KDF is a key derivation function. Other one-way functions can be used as well to create the authentication data as a one-way function of the identifier. Additional references to a hash throughout this disclosure can similarly be replaced with some other one-way function, such as a key derivation function (KDF), a Message Authentication Code function (e.g., HMAC), or other one-way function that deterministically transforms and/or irreversibly obscures the input data.

Once the AuthData(t) has been generated, it is used by the owner computing device 50 to authenticate new and strong cryptographic key material so that the gateway computing device 14 can use it to encrypt the encrypted data it receives from the beacon computing device 12 at time t. Since the owner computing device 50 is not necessarily online, this can be achieved using the daily list of hashed EIDs that the owner computing device 50 sends the server computing device 16. Specifically, the owner computing device 50 adds to each H(EID(t)) entry in the list a new and strong ephemeral cryptographic key material and its authentication (i.e. MAC value) generated using AuthData(t). One example reason for the cryptographic key material to be ephemeral is to avoid tracking of the beacon computing device 12. Note, however, that the use of an ephemeral cryptographic material is not required; Alternative implementations of the present disclosure may use static cryptographic material.

This process can be done as follows. For each time t, the owner computing device 50 generates a cryptographically strong ephemeral DH pair (pk(t), sk(t)) (where pk(t) is the public key and sk(t) is its secret key part). The owner computing device 50 then authenticates pk(t) using AuthData(t). Each entry in the list thus becomes a triple (EID(t), pk(t), MAC (pk(t))) (where the MAC value is computed using AuthData(t)).

When a gateway computing device 14 receives an EID(t) and encrypted data from a beacon computing device 12 (represented in FIG. 2B as Enc(msg)), it can send H(EID(t)) to the server computing device 16. The server computing device 16 finds the respective pk(t) and MAC (pk(t)) in its table and sends them to the gateway computing device 14.

In some implementations, the indirect communications between the owner computing device 50 and the gateway computing device 14 can be encrypted using one or more encryption techniques. Specifically, in some implementations, each pk(t) and MAC (pk(t)) in the list sent by the owner computing device 50 to the server computing device 16 are instead replaced by the owner computing device 50 with Enc “pk(t) and MAC (Enc″pk(t)), where, for example, the encryption key for performing (and decrypting) Enc” is generated from AuthData. Note that communication between the server computing device 16 and the gateway computing device 14 may also be encrypted using e.g., SSL but this is not necessarily part of the protocol.

The gateway computing device 14 then verifies MAC (pk(t)) using AuthData(t), encrypts the beacon's encrypted data using pk(t) and sends this encrypted data to the server computing device 16. In FIG. 2B, the data that is further encrypted by the gateway computing device 14 is represented as Enc′ (Enc(msg)), where Enc′( ) is performed using pk(t). The rest may be as is performed in the original protocol.

Note that the beacon's message is encrypted twice-first the plaintext message is encrypted by the symmetric (and likely weaker) algorithm in the beacon computing device 12, and then the resulting encrypted message is further encrypted using pk(t) by the gateway computing device 14. It is important to note that the illustrated version of this solution includes owner-to-gateway communication for each beacon's message whereas this is not required during normal operation. Note also that in the illustrated version of this solution pk(t) is delivered to the gateway computing device 14 through the server computing device 16 but being authenticated by AuthData(t), the server computing device 16 cannot apply a man in the middle (MITM) attack and replace pk(t) with a key of its choosing.

According to another aspect of the present disclosure, some example approaches provide agility by design. For example, in some implementations, the different cryptographic operating modes respectively include application of two different encryption algorithms. Thus, in some implementations, the first cryptographic operating mode can include generating an identifier or encrypting a message according to a first encryption algorithm. The second cryptographic operating mode can include generating the identifier or encrypting the message according to a second encryption algorithm that may have stronger security guarantees than the first encryption algorithm. Note that it may not be known at the time of deployment that the second encryption algorithm affords stronger security guarantees, but this may become apparent after deployment and therefore inclusion of the second encryption algorithm enables switching to the second encryption algorithm in the case that the first encryption algorithm ultimately turns out to be weak.

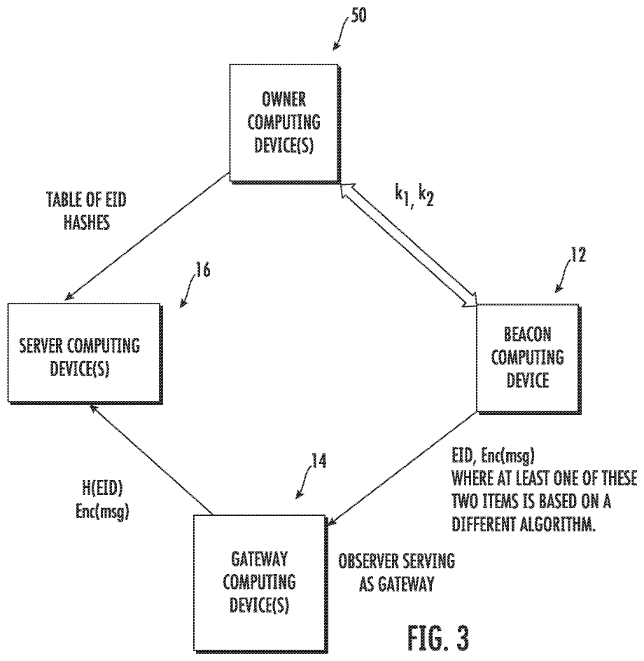

As one example, FIG. 3 depicts a solution by replacing weak algorithms. In particular, FIG. 3 depicts a block diagram of an example computing system operating in an example cryptographic operating mode in which the transmitter computing device uses a second, different cryptographic algorithm according to example embodiments of the present disclosure.

In particular, as shown in FIG. 3, and as part of the system design, the beacon computing device 12 can be provided with additional cryptographic symmetric mechanisms. Therefore, in case that one or more of the current cryptographic mechanisms turns up to be weak because of its (or their) internal design rather than the length of its cryptographic keys, the beacon computing device 12 can use the different mechanism or mechanisms.

This update type completely restores the security of the whole system including the beacon-gateway link. Additionally, this solution maintains the gateway-owner computing device 50 direction only (after the gateway computing device 14 gets the beacon's message) and does not require communication in the owner-gateway direction (e.g., except for one-time communication requesting the beacon computing device 12 to move into this mode) as is the case in the above solution and in several of the solutions illustrated in follow figures.

According to another aspect of the present disclosure, in some implementations, the different cryptographic operating modes respectively include application of different numbers or rounds of encryption algorithms. Thus, in some implementations, the first cryptographic operating mode can include generating an identifier or encrypting a message according to a single application of an encryption algorithm. The second cryptographic operating mode can include generating the identifier or encrypting the message according to multiple applications of one or more encryption algorithms.

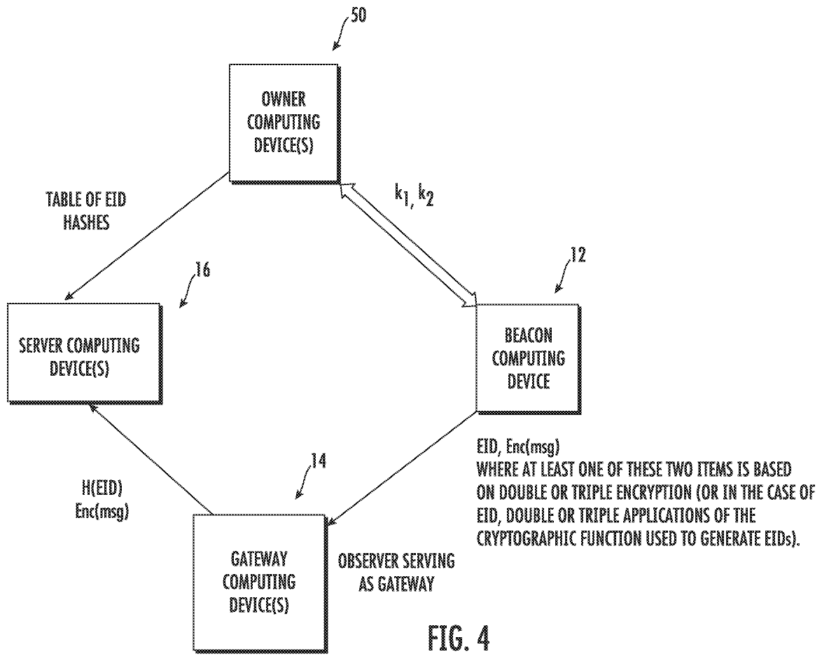

As one example, FIG. 4 depicts an example solution by double or triple encryption. In particular, FIG. 4 depicts a block diagram of an example computing system operating in an example cryptographic operating mode in which the transmitter computing device performs multiple rounds of encryption according to example embodiments of the present disclosure.

More particularly, as shown in FIG. 4, and as part of the system design, the beacon computing device 12 can be provided with the ability to use double or triple encryption with its installed algorithms (e.g., and optionally similarly for Message Authentication Code computations). With respect to the EID, the beacon computing device 12 can be provided with the ability to use double or triple applications of the function used to generate the EID.

Note that such a change requires the beacon computing device 12 and the gateway computing device 14 to invest additional computation time and additional battery power and this may affect the system as a whole. Again, this type of update (e.g., if possible given the system constraints) completely restores the security of the whole system including the beacon-gateway link. Additionally, as in the previous solution, this solution maintains the gateway-owner computing device 50 direction only.

According to another aspect of the present disclosure, in some implementations, the different cryptographic operating modes respectively include generation of different amounts or types of identifiers or authentication data that have different cryptographic strengths. Thus, in some implementations, the first cryptographic operating mode can include generating, by a transmitter device, a first identifier using a symmetric key. The second cryptographic operating mode can include generating the first identifier using the symmetric key, and further generating a set of authentication data using a cryptographic key that differs from the symmetric key (e.g., the authentication data may be generated using public-key cryptography mechanisms).

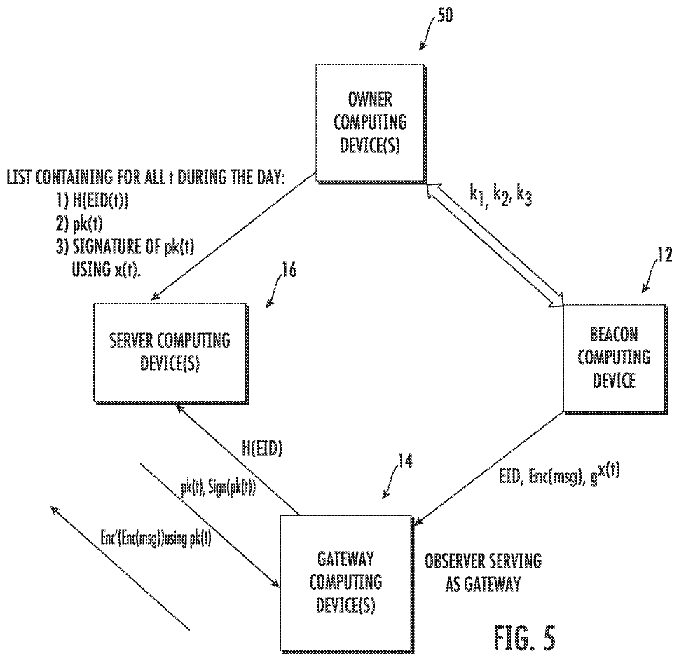

As one example, FIG. 5 depicts an example solution that includes advertising stronger authentication data. In particular, FIG. 5 depicts a block diagram of an example computing system operating in an example cryptographic operating mode in which the transmitter device advertises additional, stronger authentication data according to example embodiments of the present disclosure.

More particularly, as illustrated in FIG. 5 and as part of the system design, the beacon computing device 12 can be provided with the ability to advertise additional data that could be used as a stronger form of the AuthData used in the solution shown in FIG. 2B. Specifically, AuthData as used in FIG. 2B was based on the EID (specifically, the example implementation discussed with reference to FIG. 2B used AuthData(t)=H(EID(t)∥“data”)).

However, since the beacon computing device 12 advertises over the air, the EID is visible to any attacker and thus even a passive attacker on the beacon-gateway link can generate the AuthData. Therefore, as illustrated in FIG. 5, a stronger form of AuthData is an ephemeral Diffie-Hellman (DH) public key whose secret part is known to the owner computing device 50. Specifically, the beacon computing device 12 and owner computing device 50 can share another secret key k3. The DH ephemeral secret key at time t can be based on k3 and the time t and denoted x(t). The DH ephemeral public key would then be g^{x(t)} where g is the DH group generator (or the group's base point if an elliptic curve group is used). The beacon computing device 12 then adds g^{x(t)} to its advertisement at time t. Note that ephemeral public keys are not strictly required; Alternative embodiments may use static public keys.

Note that g^{x(t)} can indeed serve as AuthData (at time t) since the owner computing device 50 can use x(t) to sign the new cryptographic key material and the gateway computing device 14 can verify such a signature using g^{x(t)}. The new cryptographic key material that is signed by the owner device 50 is represented in FIG. 5 using the notation Sign (pk(t)), where the signature is verifiable using g^{x(t)}. As in the solution shown in FIG. 2B, for each time t the owner computing device 50 adds the new cryptographic key material and its signature to the respective entry in the daily list of hashed EIDs it sends to the server computing device 16.

Note also that g^{x(t)} is indeed a stronger form of AuthData since it can only be attacked by an active MITM attacker on the beacon-gateway link. Note that such a change may require the beacon computing device 12 to advertise twice for a single logical message and this may have the effect that potential gateways miss one of the advertisements and thus the whole logical message. Furthermore, as in the solution shown in FIG. 2B, in FIG. 5 the beacon computing device 12 and the gateway computing device 14 would need to invest additional computation time and additional battery power. This type of update (e.g., if possible given the system constraints) restores the security of the whole system including the beacon-gateway link assuming no active MITM attacker on the beacon-gateway link. Note that this solution includes owner-gateway communication for each message advertised by the beacon.

According to another aspect of the present disclosure, in other implementations, the first cryptographic operating mode can include generating a first identifier using a symmetric key. The second cryptographic operating mode can include generating a second identifier using a cryptographic key that differs from the symmetric key, wherein the second identifier is usable by the gateway computing device 14 either: (i) as a set of authentication data for the computing device; or (ii) to generate the set of authentication data for the computing device.

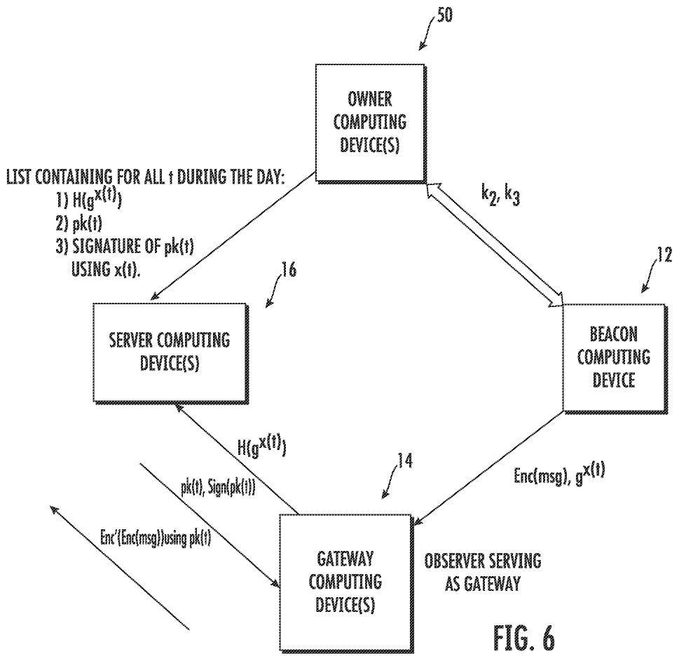

As one example, FIG. 6 depicts an example solution by advertising stronger AuthData and also using it as an identifier. In particular, FIG. 6 depicts a block diagram of an example computing system operating in an example cryptographic operating mode in which the transmitter computing device advertises stronger authentication data which is also used as identifier for the transmitter computing device according to example embodiments of the present disclosure.

The solution shown in FIG. 6 enables the beacon computing device 12 to only use a single advertisement per logical message. Specifically, in FIG. 6, the value of g^{x(t)} from FIG. 5 is additionally used as the EID for the beacon device 12. Thus, instead of advertising at time t a triple (EID(t), Enc(msg), g^{x(t)}) where EID(t) is generated using k1, the encrypted data Enc(msg) is generated using k2 and g^{x(t)} is generated using k3, the beacon computing device 12 would only advertise the pair (Enc(msg), g^{x(t)}) (so k1 is not needed in this solution). The value g^{x(t)} now serves as both an ephemeral ID and as AuthData (at time t). Note that ephemeral IDs are not strictly required; Alternative implementations may use a static ID.

Specifically, in the daily list the owner computing device 50 sends to the server computing device 16, the hash of the EID at time t is now H (g^{x(t)}). Note again that the use of a hash function is provided as an example. Other one-way functions such as key derivation functions or other functions could optionally be used instead. Alternatively, application of such a one-way function is not essential given that the use of g^{x(t)} as a public key does not reveal the secret x(t) which is used to sign the new cryptographic parameters. Similarly, when a gateway computing device 14 receives g^{x(t)} and the respective encrypted data Enc(msg) from a beacon, the gateway computing device 14 sends H (g^{x(t)}) to the server computing device 16. Other details of this solution may be the same as in the previous solution. Specifically, an entry containing H (g^{x(t)}) in the daily list sent by an owner computing device 50 to the server computing device 16 includes also a new ephemeral key material and its signature. Then, when the server computing device 16 receives H (g^{x(t)}) from a gateway, it sends to the gateway computing device 14 the respective new ephemeral key material and its signature. Finally, the gateway computing device 14 verifies the signature using g^{x(t)} and then uses the new key material to further encrypt the encrypted data received from the beacons and send it to the server computing device 16. In FIG. 6, the data that is further encrypted by the gateway computing device 14 is represented as Enc′(Enc(msg)), where Enc′( ) is performed using pk(t), which is the new key material.

This type of update restores the security of the whole system including the beacon-gateway link assuming no active MITM attacker on the beacon-gateway link. It includes owner-gateway communication for each message advertised by the beacon computing device 12.

In some implementations, the indirect communications between the owner computing device 50 and the gateway computing device 14 can be encrypted using one or more encryption techniques. Specifically, in some implementations, each pk(t) and signature (pk(t)) in the list sent by the owner computing device 50 to the server computing device 16 are instead replaced by the owner computing device 50 with Enc″pk(t) and signature (Enc″pk(t)), where, for example, the encryption key for performing (and decrypting) Enc″ is generated from x(t). Note that communication between the server computing device 16 and the gateway computing device 14 may also be encrypted using e.g., SSL but this is not necessarily part of the protocol.

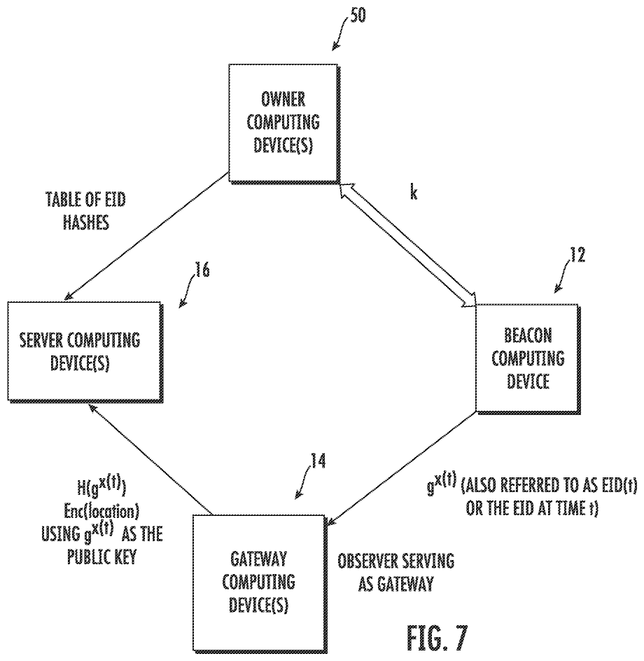

According to another aspect of the present disclosure, another example setting that the approaches described herein (e.g., system 10 of FIG. 1) can be applied is for devices in a device finding system, such as a crowdsource device finding system. An example device finding system is depicted in FIG. 7 and is designed to enable an owner computing device 50 to locate lost items. The device finding system considered in the illustrated examples is end-to-end. Thus, a server computing device 16 receives messages containing encrypted beacons' locations and must associate each such message with the right beacon's owner computing device 50 (but be unable to decrypt the location). However, non-end-to-end approaches are possible as well.

More particularly, FIG. 7 depicts a block diagram of an example device finding computing system operating in an example second base cryptographic operating mode according to example embodiments of the present disclosure. The system illustrated in FIG. 7 can operate as follows:

Initialization: A symmetric cryptographic key k is shared between the owner computing device 50 and its beacon computing device 12. As will be detailed below, at time t the beacon computing device 12 uses k to generate x(t), a DH ephemeral secret key, and g^{x(t)} the respective DH ephemeral public key. g^{x(t)} is advertised by the beacon computing device 12 and is used as both an ephemeral ID (EID for short) and as a public key which enables a nearby gateway computing device 14 to encrypt its location. Note that ephemeral IDs and public keys are not strictly required; Alternative implementations may use static IDs and/or public keys.

Daily operation: Every day each owner computing device 50 sends to a central server computing device 16 a list containing H (g^{x(t)}) for each time t, where H is a cryptographic hash function. Note again that the use of a hash function is provided as an example. Other one-way functions such as key derivation functions or other functions could optionally be used instead. Alternatively, application of such a one-way function is not essential given that the use of g^{x(t)} as a public key does not reveal the secret x(t) which is used to sign the new cryptographic parameters. The server computing device 16 generates a table from all owner computing device lists that maps each H (g^{x(t)}) to the respective owner computing device 50. The table can be referred to as the mapping table.

### Normal Operation:

At time t, the beacon computing device 12 advertises g^{x(t)}.

A nearby smartphone (or other device) acting as a gateway computing device 14 picks up g^{x(t)}. It then encrypts its location using, for example, an Elliptic Curve Integrated Encryption Scheme (ECIES) where g^{x(t)} is used as the public key. The gateway computing device 14 then sends H (g^{x(t)}) (where H is a cryptographic hash function) and the gateway's encrypted location Enc (location) to the central server computing device 16 (e.g., this can be a mobile ad-hoc network operation which is typically implemented in a layer away from the user and is automatically performed by the phone).

The server computing device 16 associates H (g^{x(t)}) with the right owner computing device 50 using the mapping table. The owner computing device 50 can thereafter access the server computing device 16, get the encrypted location of the gateway computing device 14 and decrypt it by generating the secret key x(t) using its knowledge of k (recall that the location was encrypted using the respective public key g^{x(t)}).

However, as described above, in some cases the beacon computing device 12 may be unable to be updated or difficult to update after deployment. This can result over time in degraded security of the encrypted message. For example, the encryption technique used by beacon computing device 12 may lose its effectiveness. In that case, the system may be susceptible to attack by an observing device.

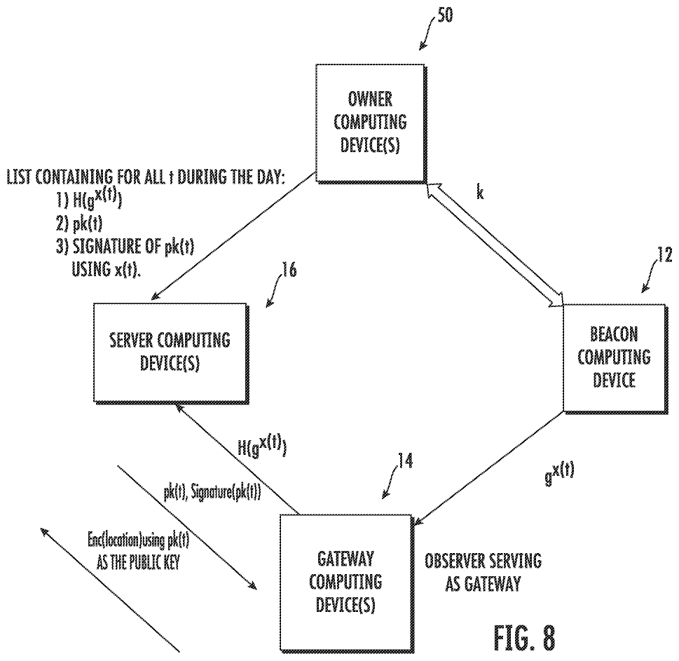

In view of the above challenge, aspects of the present disclosure provide solutions that provide agility in the face of non-updatable transmitter devices. As one example FIG. 8 depicts an ad hoc solution to non-updateable transmitter devices. In particular, FIG. 8 depicts a block diagram of an example computing system operating in an example cryptographic operating mode in which the gateway computing device 14 uses authentication data to obtain and use additional cryptographic key material according to example embodiments of the present disclosure.

In particular, as illustrated in FIG. 8, to handle a case of non-updateable beacons, the EID g^{x(t)} can be used as AuthData at time t to deliver to the gateway computing device 14 new and stronger key material in a similar way as was discussed with reference to FIGS. 5 and 6. However, in the case of the device finding system of FIG. 8, g^{x(t)} is advertised by the beacon computing device 12 already in the original system (e.g., shown in FIG. 7). Therefore, the solution of FIG. 8 does not need any changes in the beacon computing device 12 and can therefore be ad-hoc.

Specifically, the owner computing device 50 modifies the daily list it sends to the server computing device 16 as follows. For each time t, the owner computing device 50 adds, to the entry containing H (g^{x(t)}), new cryptographic key material and a signature using x(t) of the new cryptographic key material.

When a gateway computing device 14 receives some g^{x(t)} from a beacon computing device 12 it sends H (g^{x(t)}) to the server computing device 16. The server computing device 16 locates the respective entry in the mapping table and sends to the gateway computing device 14 the new cryptographic key material and its signature. The gateway computing device 14 verifies the new cryptographic key material, uses it to encrypt its location, and sends the encrypted location to the server computing device 16.

This type of update restores the security of the whole system including the beacon-gateway link assuming no active MITM attacker on the beacon-gateway link. It includes owner-gateway communication for each message advertised by the beacon computing device 12. In some implementations, the indirect communications between the owner computing device 50 and the gateway computing device 14 can be encrypted using one or more encryption techniques.

According to another aspect of the present disclosure, some example approaches can provide agility by design. For example, in some implementations, the different cryptographic operating modes respectively include generation of public keys using different seed material and/or key generation algorithms. Thus, in some implementations, the first cryptographic operating mode can include generating a public key according to a first cryptographic mechanism. The second cryptographic operating mode can include generating the public key according to a second cryptographic mechanism that may have stronger security guarantees than the first cryptographic mechanism. Note that it may not be known at the time of deployment that the second cryptographic mechanism affords stronger security guarantees, but this may become apparent after deployment and therefore inclusion of the second cryptographic mechanism enables switching to the second cryptographic mechanism in the case that the first cryptographic mechanism ultimately turns out to be weak.

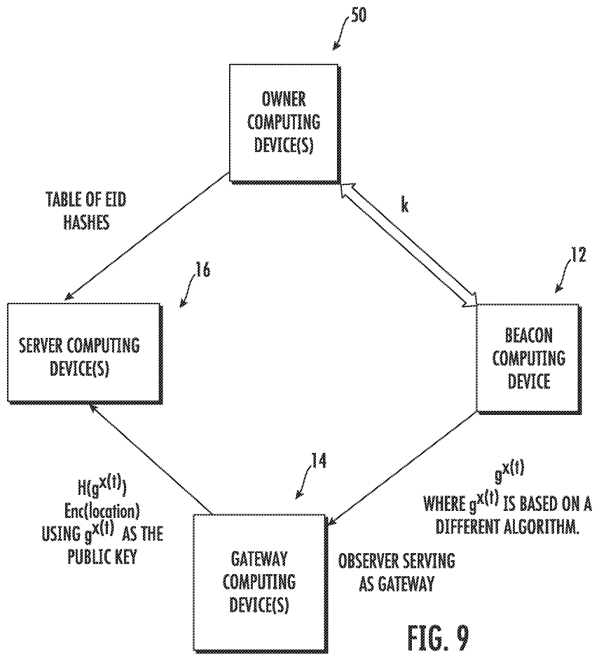

As one example, FIG. 9 depicts an example solution by replacing weak algorithms. In particular, FIG. 9 depicts a block diagram of an example computing system operating in an example cryptographic operating mode in which a transmitter computing device uses a second, different cryptographic algorithm according to example embodiments of the present disclosure.

More particularly, as illustrated in FIG. 9, and as part of the system design, the beacon computing device 12 can be provided with additional cryptographic asymmetric mechanisms for generating the EID so that in case the current cryptographic mechanism turns up to be weak because of its (or their) internal design rather than the length of its cryptographic keys, the beacon computing device 12 could use the different mechanism. For example, the beacon computing device 12 can be provided with algorithms for additional elliptic curves groups so that if the current elliptic curve (EC) group turns out to be weak, the beacon computing device 12 can use a different EC group. This update type completely restores the security of the whole system and maintains the gateway-owner computing device 50 direction only.

According to another aspect of the present disclosure, in some implementations, the different cryptographic operating modes respectively include using different types of cryptographic keys. Thus, in some implementations, the first cryptographic operating mode can include generating a public key using an asymmetric private key and transmitting the public key to a gateway computing device 14 for use by the gateway computing device 14 in encrypting data. The second cryptographic operating mode can include transmitting a symmetric key to the gateway computing device 14 for use by the gateway computing device 14 in encrypting data.

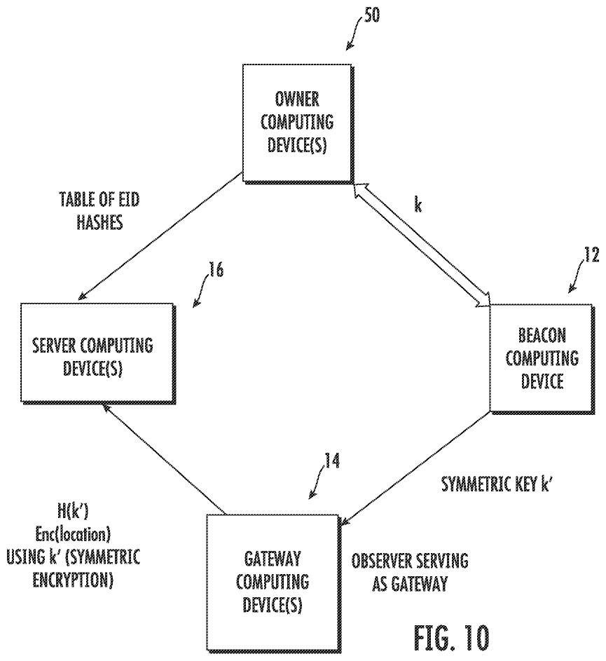

As one example, FIG. 10 depicts an example solution by replacing asymmetric key by a symmetric one. In particular, FIG. 10 depicts a block diagram of an example computing system operating in an example cryptographic operating mode in which a symmetric cryptographic key is used according to example embodiments of the present disclosure.

Specifically, denote by n the length of the DH ephemeral public key advertised by the beacon computing device 12. As explained above, the gateway computing device 14 uses it to encrypt its location. It is well known that the security provided by DH encryption is of (at most) n/2 bits (that is, an attack requires O(2^{n/2}) time). On the other hand, the security of a (good) symmetric encryption algorithm with n bits key is n bits (so that an attack requires O(2ⁿ) time). One example solution is thus that as part of the system design the beacon computing device 12 can be provided with the ability to advertise in a second cryptographic operating mode a symmetric key for use with a symmetric cipher. For example, this second cryptographic operating mode can be in addition to a first cryptographic operating mode that utilizes an asymmetric key for use with a DH-based cipher.

This update type completely restores the security of the whole system provided there is no attack on the beacon-gateway link. However, where the original system is based on public-key cryptography and is thus secure against an active attack on the beacon-gateway link, the suggested solution is based on symmetric cryptography and is thus susceptible to a passive attack on the beacon-gateway link. The update maintains the gateway-owner direction only.

According to another aspect of the present disclosure, in some implementations, the different cryptographic operating modes respectively include generation of public keys using different elliptic curve groups. Thus, in some implementations, the first cryptographic operating mode can employ a first elliptic-curve cryptographic mechanism that uses a first elliptic curve group. The second cryptographic operating mode can employ a second elliptic-curve cryptographic mechanism that uses a second elliptic curve group that has stronger security guarantees than the first elliptic curve group.

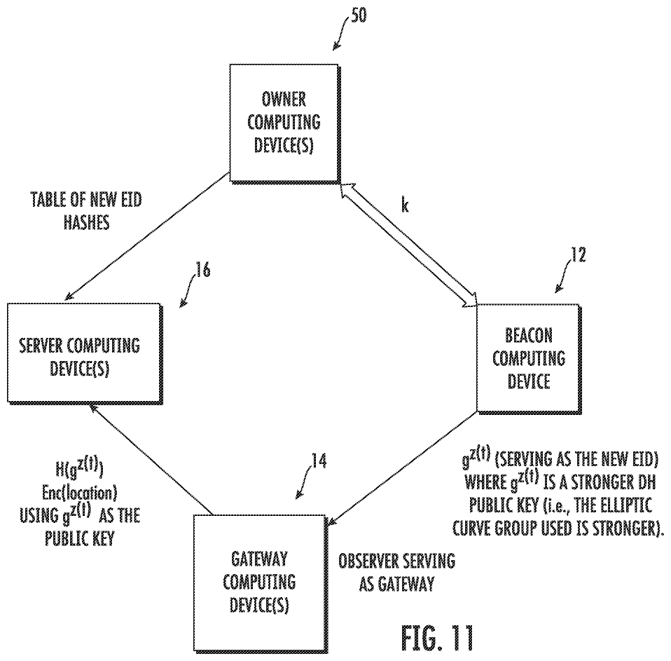

As one example, FIG. 11 depicts an example solution that includes advertising a stronger public key. In particular, FIG. 11 depicts a block diagram of an example computing system operating in an example cryptographic operating mode in which the transmitter computing device uses a stronger elliptic curve group to generate a public key according to example embodiments of the present disclosure. As illustrated in FIG. 11, as part of the system design, beacon computing device 12 can be provided with the ability to generate a DH ephemeral public key from a more secure elliptic curve group.

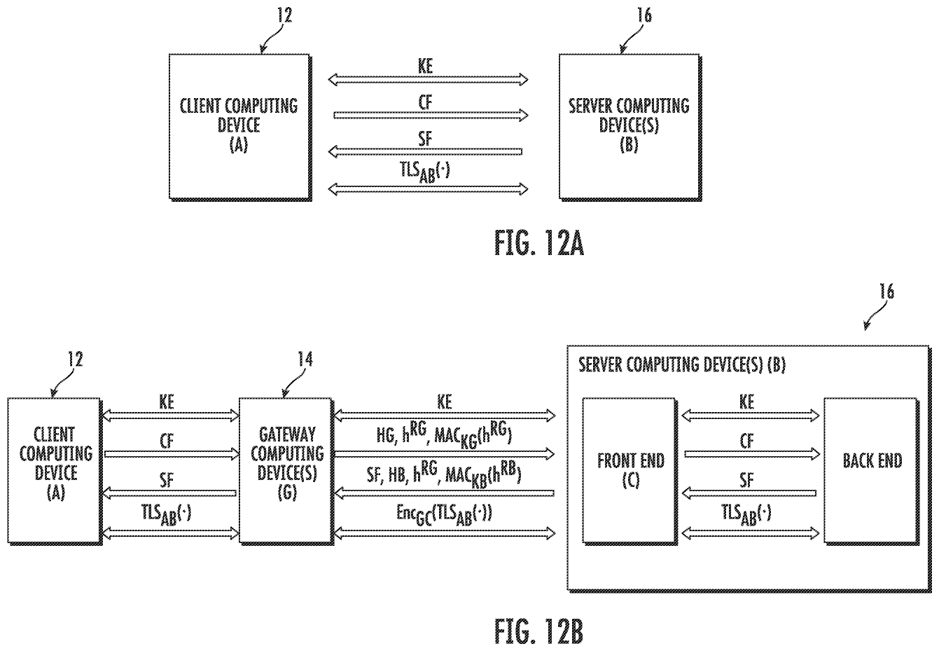

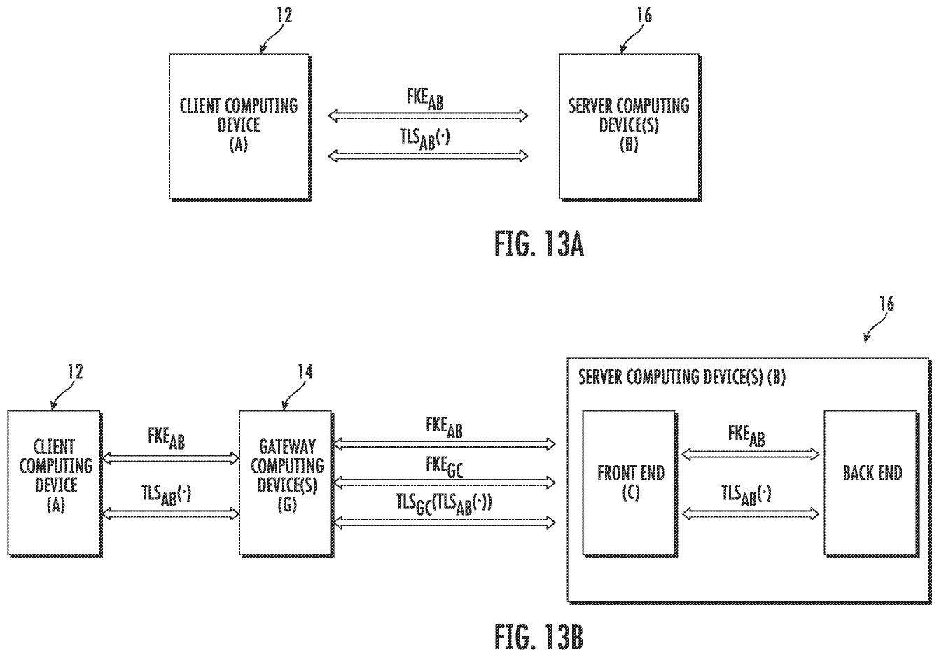

According to another aspect of the present disclosure, another example setting that the approaches described herein can be applied is for devices communicating using a Transport Layer Security (TLS) protocol. FIGS. 12A and 13A depict computing systems operating according to base TLS protocol operating modes.

TLS is an encryption and authentication protocol designed to secure Internet communications. A TLS handshake generally refers to the process that kicks off a communication session that uses TLS. During a TLS handshake, the two communicating devices can exchange messages to acknowledge each other, verify each other, establish the cryptographic algorithms they will use, and agree on session keys. After session keys have been established, each device can send a finished message. For example, the client can transmit a client finished portion that indicates the client is ready. The client finished portion can be encrypted with a session key. Similarly, the server can transmit a server finished portion that indicates the server is ready. The server finished portion can be encrypted with a session key. A payload can be encrypted using the session key and transmitted between the parties. In computing and telecommunications, the payload generally refers to the part of transmitted data that is the actual intended message.

More particularly, referring now to FIG. 12A, in the TLS context a cipher suite agreed upon between a transmitting computing device 12 (denoted by ‘A’) and a receiver computing device 16 (denoted by ‘B’, one example of which is a server) in TLS may not necessarily be strong enough since the receiver computing device 16, the transmitting computing device 12, or both may not support a cipher suite of a desired strength, or as a result of flawed implementation or for other reasons. Moreover, one of the sides (transmitting computing device 12 or receiver computing device 16) may support a weak version of the TLS protocol. For the sake of this example assume that the side with weak cryptography is the transmitting computing device 12, but the transmitting computing device 12 is non-updatable.

In some implementations, the different cryptographic operating modes can include changes to how the TLS protocol is implemented. In some of such implementations the transmitter computing device 12 can be a client computing device and the receiver computing device 16 can be a server computing device.

Recall that each data packet exchanged between the client and server goes through multiple hops and so the server in the first hop from A or the next server if the first server cannot help, or the next one etc. (where the helping server is denoted G and serves as the gateway computing device as described herein) may be able to negotiate with B a stronger cipher suite or agree on encryption/authentication outside the TLS protocol.

Specifically, FIGS. 12B and 13B describe possible solutions by which G and B can agree on new (and stronger) cryptographic key material that will enable them to encrypt and authenticate the session's (already encrypted) data. Although FIGS. 12A-13B are illustrated and discussed with reference to an example setting in which the transmitting computing device 12 is a client computing device 12 and the receiver computing device 16 is a server computing device 16, the proposed solutions are not limited to this example context.

As one example, FIG. 12B depicts an example solution in which the client finished portion of a TLS communication is used as AuthData. In particular, FIG. 12B depicts a block diagram of an example computing system operating in an example cryptographic operating mode in which a client finished portion of a TLS communication is used as authentication data according to example embodiments of the present disclosure.

As illustrated in FIG. 12B, one example solution is to use A's finished message as the AuthData. This is possible since A's finished message is pseudorandom and B can generate it by itself.

Assume that the new cryptographic mechanisms have been already agreed upon between B and G. This agreement can be achieved for example by fixing the cryptographic mechanisms that are to be used in the protocol, or by the server computing device deciding on the cryptographic mechanisms and notifying the gateway (authenticated by AuthData) or by a table known to all the protocol's participants (e.g., a table which for each weak cipher suite determines the cryptographic mechanisms that are to be used in this solution when the cipher suite is used).

Assume further for the sake of exposition that the specific cryptographic mechanisms agreed between G and B are based on Diffie-Hellman key exchange (e.g., from some agreed upon elliptic curve group with known parameters) and G and B are thus required to send one another h^{RG} and h^{RB} respectively, where h is the agreed upon elliptic curve group based point and RG and RB are the random DH ephemeral private keys of G and B, respectively. Let H be the agreed upon hash function and let KG=H(AuthData∥“KG”), KB=H(AuthData∥“KB”), HG=H(AuthData∥“HG”) and HB=H(AuthData∥“HB”). Note again that the use of a hash function is provided as an example. Other one-way functions such as key derivation functions or other functions could optionally be used instead.

When G receives the client finished message from A, it sends to B instead of the finished message the triple (HG, h^{RG}, MAC_{KG}(h^{RG})). Removing the client finished message is important for the protocol security since otherwise it would be possible for servers further on the path from A to B to forge an authenticating triple.

B sends to G the triple (HB, h^{RB}, MAC_{KB}(h^{RB}) (e.g., in addition to the server's finished message). The first item in each of the two triples proves that the respective sender knows AuthData, the second item is the random DH ephemeral public key for the DH key exchange, and the third item authenticates the second item.

The method works if the entire communication session between A and B travels through G. This can be enforced using segment routing (e.g., even if G is not the next hop from A).

FIG. 12B depicts this approach. In FIG. 12B the server computing system 16 includes a front end component (which may be denoted as component C) which is responsible for establishing and maintaining the secure channel between B and G. Note that in practice the front end C is part of B.

Denote by KE the part of the TLS key exchange protocol between A and B that precedes the client finished and server finished messages, denote by CF the client finished message, and denote by SF the server finished message. In addition, denote by TLS_{AB}(⋅) the weak encrypted and authenticated TLS session between A and B (where “.” represents the plaintext data) and by Enc_{GC}(⋅) the strong encrypted and authenticated communication between G and front end C. FIG. 12A represents the original TLS key exchange and the resulting TLS secure session between A and B and FIG. 12B represents the solution in which the client finished is used as AuthData.

As another approach for improved communications, FIG. 13B depicts a block diagram of an example computing system operating in an example cryptographic operating mode in which the gateway computing system initiates a second secure communication session which encapsulates a first secure communication session according to example embodiments of the present disclosure. The solution shown in FIG. 13B can be applied to any secure message transmission protocol. One example of a secure message transmission protocol is the Transport Security Layer (TLS) protocol. FIG. 13B is illustrated in this example context. However, although TLS is used in FIG. 13B to illustrate the solution, the proposed techniques can be alternatively applied to various other secure message transmission protocols. Other example secure message transmission protocols are the class of end-to-end encrypted protocols such as, for example, the Signal protocol. Thus, while FIG. 13B represents an example application to perform TLS within TLS, the proposed technique can be generally applied to any secure message transmission protocol.

Referring now to FIG. 13B, the solution shown in FIG. 13B may require significant modifications of the TLS protocol: G and B would establish a TLS session with strong cipher suite and this TLS session would encapsulate the TLS session between A and B.

Specifically, during the TLS key exchange between A and B, G delivers to B an indication of its willingness to participate in a TLS session within TLS session where the TLS session of A with B with the weak cipher suite (or otherwise weak security) would be encapsulated within a TLS session of G with B with a strong cipher suite. The indication can be, e.g., in the form of G starting a TLS key exchange protocol with B by piggybacking on the TLS key exchange messages of A and B. B can indicate its willingness for the TLS within TLS by continuing the key exchange protocol with G (again piggybacking on the key exchange protocol of A and B).

Alternatively, the key exchange protocol between G and B can start after the end of the key exchange protocol between A and B. In any case, following the key exchange between G and B, the session between A and B would be doubly secured-first by the protection provided by TLS session of A and B and secondly (and over this encrypted and authenticated session) by the protection provided by TLS session of G and B.

Note that a TLS session between G and B can be established even when the (original) TLS session between A and B changes paths and, in particular, does not flow through the same gateway G throughout the session.

FIG. 13B illustrates this approach where (as in FIG. 12B) a front end component C is shown in the server computing device 16 that is responsible for establishing and maintaining the secure channel between G and B. The term FKE_{XY} denotes a full TLS key exchange protocol including client and server finished messages between X and Y. The term TLS_{XY}(⋅) denotes the encrypted and authenticated TLS session between X and Y that follows FKE_{XY}. FIG. 13A represents the original TLS key exchange and the resulting TLS secure session between A and B and FIG. 13B represents the solution that uses TLS within TLS.

One result of the approach shown in FIG. 13B is that each packet would be protected by the weaker cipher suite only in the first hop (or if G is not the first hop after A, only in the part of communication between A and G) and would be protected by both the weaker inner cipher suite and the stronger outer suite between G and B. As already indicated, if G is not able to negotiate a suitable cipher suite with B as well, then the server G′ where G′ is the next hop after G may be able to negotiate such a suitable cipher suite with B, etc. Applying the proposed approach in this manner minimizes the prefix of exposure. Note that unlike services which “break” the TLS and serve as content readers (e.g., so-called “middleboxes”), the goal here is to increase security on the suffix of the route (rest of the system) and not relying on any decryption of any ciphertext (old or new).

Additional example approaches improve TLS via agility by design. In particular, since TLS is a standard that defines among other things the cryptographic algorithms it uses, some of the solutions described earlier with respect to non-updateable components such as BLE beacons are unlikely to be used in the context of TLS. For completeness, two alternative approaches are mentioned: (i) installing additional cryptographic algorithms into the non-updateable component and (ii) instructing the non-updateable component to use double or triple encryption whenever encrypting data (or symmetrically authenticating data).

Another possible solution provided by the present disclosure adds data that can serve as authentication data (“AuthData”) between a gateway computing device (denoted by G) and a receiver computing device (denoted by B). Specifically, a non-updateable component (e.g., a transmitter device denoted as A) can be provided with the ability to add into its messages (e.g., perhaps as an extension of the TLS protocol) additional data that can serve as AuthData and enable G and B to establish secure communication even when the TLS session between A and B changes paths and, in particular, does not flow through the same gateway G throughout the session.

An example for such AuthData is B's certified public key (e.g., possibly with other parameters of the current TLS session between A and B such as the cipher suite). Establishing secure communication between G and B can then be done using AuthData. For example, if the additional data is B's certified public key and the cipher suite used on the TLS session between A and B is weak, G and B can apply key exchange similar to the way it is done in TLS or use some agreed upon scheme (e.g., the scheme can be dependent on the cipher suite used in the TLS session between A and B).

Furthermore, the additional AuthData may include data that is pseudorandom but can be generated by B. This is easy to do since A and B have already agreed on common secrets. Inclusion of such AuthData allows G and B to establish secure communication similar to the way it is done in the above solution that uses the client finished message.

As noted above, since in this solution, AuthData is sent with each message, G does not have to be fixed. However, as long as the TLS session between A and B flows through the same G, G may use one of the previous solutions described above (and ignore B's additional AuthData). The solution described in this subsection is more suitable for cases where a gateway G receives a TLS frame of an already established TLS session.

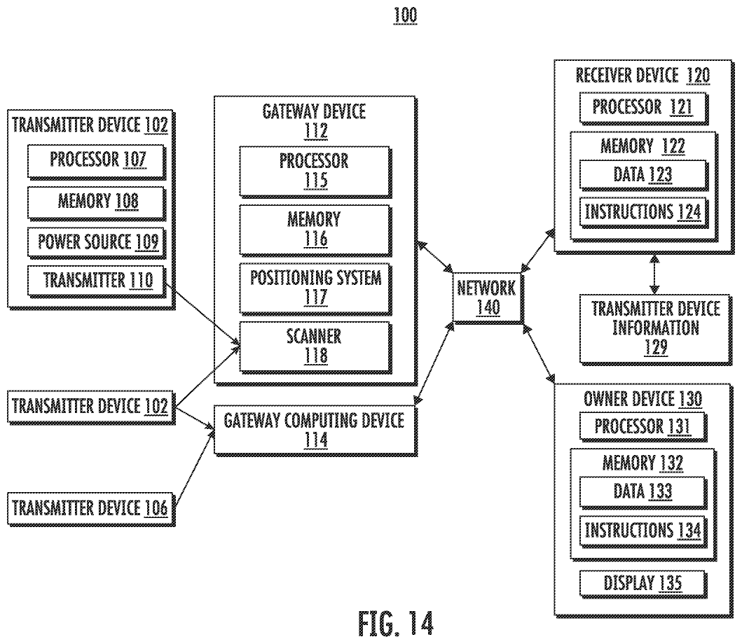

FIG. 14 depicts an example system 100 according to an example embodiment of the present disclosure. System 100 includes a plurality of transmitter devices 102-106; one or more gateway computing devices 112 and 114; a receiver device 120; and an owner computing device 130. The one or more gateway computing devices 112 and 114, the receiver device 120, and the owner computing device 130 are communicatively coupled over a network 140.

The transmitter devices 102-106 can be used for many different applications, including, for example, co-presence (e.g., two entities becoming aware of each other), location-based gaming, asset tracking, transmitter device localization or gateway computing device localization, telemetry (e.g., temperature reporting), information provisioning (e.g., use of a gateway computing device to obtain various information such as semantic information or geographic information associated with transmitter devices 102-106 as the gateway computing device moves about the world), intra-beacon communication, payment systems, security, etc. The present disclosure provides a general system that can be applicable to the above noted applications or other applications as well.

The transmitter devices 102-106 each include one or more processors 107 and a memory 108. The processor 107 can be any processing device such as a controller, microcontroller, microprocessor, ASIC, or other processing device and can be one processor or a plurality of processors that are operatively connected.

The memory 108 can store instructions that, when implemented by the one or more processors 107, cause the one or more processors to perform operations to provide functionality. The memory 108 can also store various data, including an identifier associated with the transmitter device.

The transmitter devices 102-106 also each include a power source 109 and a transmitter 110. The power source 109 can be, for example, one or more of various types of batteries. The transmitter devices 102-106 can include various other components such as sensors, as well. In such instances, the memory 108 can store data collected by such sensors.

Transmitter devices 102-106 can be computing devices that are configured to emit messages or other signals. For example, the messages can be advertising frames that are broadcast by the transmitter devices 102-106. The advertising frames can include various information, including, for example, an identifier that uniquely identifies the broadcasting transmitter device; current power source characteristics (e.g., state of charge and/or power source voltage); temperature; total number of frames broadcast; initialization date; battery type; transmission rate; transmission power; a URL; and/or other various information. In some instances, the transmitter device broadcasts only its unique identifier.

In some implementations, the advertising frames can be used for the purpose of being “noticed” but not connected to. Thus, in such implementations, the entirety of the interaction between the transmitter devices 102-106 and the gateway computing devices 112 and 114 can be performed without requiring a connection between the gateway computing device and the transmitter device or a connection between the transmitter device and the receiver device 120. Instead, all relevant information for the interaction is contained within the advertising packets emitted by the transmitter device. Limiting transmitter device interaction to the broadcasting of advertising frames can provide a nominal behavior that allows energy consumption and service life to be modeled and reasonably predicted.

In other implementations, however, the transmitter devices 102-106 can allow connections for configuration, provisioning, maintenance, firmware updates, or other functions. In yet further implementations, the transmitter devices 102-106 can be configured to provide additional information to a gateway computing device using a scan request and scan response interaction, which does not require actual connection between the devices.

The transmitter devices 102-106 can broadcast the advertising frames using short range wireless communication technologies such as, for example, Bluetooth, Bluetooth low energy, ZigBee, Near Field Communication, Wi-Fi Direct, or other technologies. Furthermore, although short range wireless communication technologies are provided as an example, any communication components can be used to transmit the advertising frames from the transmitter devices 102-106 to the gateway computing devices 112 and 114, including, for example, wired connections, general radio frequency communication components, optical communication components, infrared communication components, magnetic communication components, or other communication methods or components, including, for example, quantum communication methods or components.

Broadcasting of advertising frames can be the primary purpose of each transmitter device 102-106 or can be a secondary purpose. Thus, in various implementations of the present disclosure, each transmitter device can be a computing device dedicated to periodic broadcasting of advertising frames; an embedded system within a larger computing device or system; other devices; or combinations thereof.

Each of the transmitter devices 102-106 can be provided with an identifier at the time of provisioning. As one example, each identifier can be based in whole or in part on a Universally Unique Identifier (UUID).

Gateway computing devices 112 and 114 can be computing devices configured to receive advertising frames from each of transmitter devices 102-106. As example, gateway computing devices 112 and 114 can be user computing devices such as a smartphone, a laptop, a tablet computing device, or a wearable computing device; an embedded system on a machine; a navigational device; or combinations thereof.

Each gateway computing device 112 and 114 includes one or more processors 115 and a memory 116. The memory 116 stores instructions which, when executed by the processors 115, cause the gateway computing device 112 to perform desired functions.

In some implementations, each of the gateway computing devices 112 and 114 includes a positioning system 118. Positioning system 118 can determine a current geographic location of gateway computing device 112 and communicate such geographic location to the receiver device 120 over network 140, as discussed further below. The positioning system 118 can be any device or circuitry for analyzing the position of the gateway computing device 112. For example, the positioning system 118 can determine actual or relative position by using a satellite navigation positioning system (e.g., a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position or combinations thereof.

In the instance in which the user consents to the use of positional or location data, the positioning system 118 can analyze the position of the gateway computing device 112 as the user moves around in the world and provides the current location of gateway computing device 112 to the receiver device 120 over network 140 in the form of a plurality of observation reports, as discussed further below.

Each of the gateway computing devices 112 and 114 includes a scanner 118 that scans for or otherwise receives information broadcast by transmitter devices 102-106. The scanner 118 can be implemented at an operating system level, an application level, or combinations thereof. For example, portions of scanning functionality can be performed by a maps application.

The scanner 118 includes computer logic utilized to provide desired functionality. Thus, the scanner 118 can be implemented in hardware, firmware and/or software controlling a general purpose processor. In one embodiment, the scanner 118 includes program code files stored on the storage device, loaded into memory and executed by a processor or can be provided from computer program products, for example, computer executable instructions that are stored in a tangible computer-readable storage medium such as RAM hard disk or optical or magnetic media.

As one example, the scanner 118 can include a system on a chip (SoC) that performs low-power background scans for advertising frames, batches observed advertising frames, and performs periodic bulk-transfers to the receiver device 120 to improve energy efficiency.

According to an aspect of the present disclosure, the gateway computing device 112 can continuously or periodically upload or otherwise transmit a plurality of observation reports to the receiver device 120. Each observation report can indicate a location of the gateway computing device 112 and can identify any transmitter devices 102-106 from which the gateway computing device 112 has recently received a broadcast (e.g., within the last second).

In some instances, the gateway computing device 112 can transmit an observation report that indicates the current location of the gateway computing device 112 and indicates that the gateway computing device 112 has not recently received any broadcasts from transmitter devices. In some instances, the observation report can include various additional data received from the identified transmitter devices, including, for example, current power source characteristics (e.g., state of charge and/or power source voltage); temperature; total number of frames broadcast; initialization date; battery type; transmission rate; transmission power; a URL; and/or other various information broadcast by a transmitter device.

The receiver device 120 can be one or more computing devices configured to communicate with the gateway computing devices 112 and 114 and the owner computing devices 130 over the network 140. As an example, receiver device 120 can be one or more server computing devices. In the instance that a plurality of server computing devices are used, the server computing devices can be arranged according to any suitable computing architecture, including sequential computing architectures, parallel computing architectures, or combinations thereof.

The receiver device 120 includes one or more processors 121 and a memory 122. The memory 122 stores instructions 124 which, when executed by the processors 121, cause the receiver device 120 to perform desired functions. The memory 122 also stores various types of data 123.

Receiver device 120 can be coupled to or in communication with a transmitter device information database 129. Although database 129 is depicted in FIG. 14 as external to the receiver device 120, such database 129 can be included in memory 122 of the receiver device 120. Further, database 129 can correspond to a plurality of databases rather than a single data source.

Transmitter device information database 129 can store various information regarding each of the transmitter devices. For example, transmitter device information database 129 can store a plurality of observation reports for each of the transmitter devices 102-106. As another example, the transmitter device information database 129 can store current operational statuses for each of the transmitter devices 102-106.

The owner computing device 130 can be any computing device capable of communicating with receiver device 120 over network 140. For example, owner computing device 130 can be a user computing device, a desktop computing device, a server computing device, or other computing devices.

The owner computing device 130 includes one or more processors 131 and a memory 132. The memory 132 stores instructions 134 which, when executed by the processors 131, cause the owner computing device 130 to perform desired functions. The memory 132 also stores various types of data 133.

As one example, the memory 132 can store instructions 134 which, when executed by the processors 131, cause the owner computing device to operate a browser application. The browser application can communicate with the receiver computing device 120 to request and receive information regarding one or more transmitter devices (e.g., displayed in a dashboard user interface).

In some implementations, the owner computing device 130 can communicate with the receiver device 120 using an application programming interface (API). For example, in some implementations, the owner computing device 130 can directly retrieve Transmitter device information from the transmitter device information database 129 using the application programming interface.

Owner computing device 130 can also include a display 135. The display 135 can include any one or more of various display technologies.

Network 140 can be any type of communications network, such as a local area network (e.g., intranet), wide area network (e.g., Internet), or some combination thereof and can include any number of wired or wireless links. In general, communication between the receiver device 120 and gateway computing devices 112 and 114 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Furthermore, although each gateway computing device 112 and 114 is shown as communicating directly with the receiver device 120 over network 140, there may be any number of intervening devices between the gateway computing device 112 or 114 and the receiver device 120. As an example, in some embodiments, groups of gateway computing devices can be organized in a network (e.g., a mesh network) and can relay messages from a particular gateway computing device to the receiver device 120. The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents. As one particular example, while various implementations illustrated and discussed herein use ephemeral data, the use of such data is not strictly required; Alternative implementations may use static data instead. As another particular example, any of the communications described herein (e.g., indirect communications from an owner device to a gateway device that contain additional cryptographic material) can be encrypted using one or more additional encryption techniques.

In particular, although the Figures respectively depict communications performed in a particular order for purposes of illustration and discussion, the methods of the present disclosure are not limited to the particularly illustrated order or arrangement. The various steps of the operating modes described herein can be omitted, rearranged, combined, and/or adapted in various ways without deviating from the scope of the present disclosure.

An embodiment of a gateway computing device is configured to execute a series of operations. These operations include sending a first communication to a receiver computing device, which contains either an identifier associated with a transmitter device, a one-way function of this identifier, or a set of authentication data linked to the transmitter device. Subsequently, the gateway device receives a second communication from the receiver computing device, which is a response to the first communication and includes a set of cryptographic material. The gateway device then authenticates this cryptographic material using the provided set of authentication data. Finally, the gateway device sends a third communication to the receiver computing device, where at least a portion of this third communication is encrypted using the authenticated cryptographic material.

In some implementations, the gateway computing device, as previously described, is associated with a transmitter computing device that is a beacon device and cannot be updated. Both the gateway computing device and the receiver computing device are re-configured after deployment to facilitate the transmission of the first, second, and third communications.

In some implementations, the gateway computing device's operations include an additional step before sending the first communication. The gateway device receives an initial communication from the transmitter computing device that contains an encrypted message. The encrypted portion of the subsequent third communication sent to the receiver includes this encrypted message, which has been further encrypted using the set of cryptographic material.

In some implementations, the encrypted portion of the third communication sent by the gateway computing device includes the location of the gateway device itself, encrypted using the set of cryptographic material.

In some implementations, the second communication received by the gateway computing device includes a Message Authentication Code (MAC) value. This MAC is generated from both the set of authentication data and the set of cryptographic material. Authenticating the cryptographic material involves confirming the MAC value.

In some implementations, the set of authentication data used by the gateway computing device includes the one-way function of the identifier.

In some implementations, the identifier is generated by the transmitter computing device using a first cryptographic key, while the set of authentication data is generated using a second, different cryptographic key.

In some implementations, the transmitter computing device generates the set of authentication data, which is then included in an initial communication received by the gateway computing device from the transmitter device.

In some implementations, the first communication sent by the gateway computing device contains either the identifier or a hash of the identifier, but not the set of authentication data. The second communication includes the set of cryptographic key material accompanied by a digital signature created using the set of authentication data. The gateway device authenticates the cryptographic material by confirming the digital signature.

In some implementations, the set of cryptographic material is received by the gateway computing device from an owner computing device associated with the transmitter device.

An embodiment of a computing device is equipped to transmit data and comprises one or more processors, along with one or more non-transitory computer-readable media. These media store a first set of cryptographic instructions for data transmission according to a first cryptographic operating mode, a second set of cryptographic instructions for data transmission according to a second cryptographic operating mode with a different security profile than the first, and instructions that, when executed by the processors, cause the computing device to switch operationally from the first cryptographic operating mode to the second cryptographic operating mode.

In some implementations, the first cryptographic operating mode of the computing device involves generating an identifier or encrypting a message using a first encryption algorithm. The second cryptographic operating mode uses a second encryption algorithm with stronger security guarantees to perform the same tasks.

In some implementations, the first cryptographic operating mode of the computing device involves generating an identifier or encrypting a message using a single application of an encryption algorithm. The second cryptographic operating mode uses multiple applications of one or more encryption algorithms to perform these tasks.

In some implementations, the first cryptographic operating mode of the computing device involves generating a first identifier using a symmetric key. The second cryptographic operating mode also generates the first identifier using the symmetric key but additionally creates a set of authentication data using a cryptographic key that differs from the symmetric key.

In some implementations, the first cryptographic operating mode of the computing device involves generating a first identifier using a symmetric key. The second cryptographic operating mode generates a second identifier using a cryptographic key that differs from the symmetric key. This second identifier either comprises a set of authentication data for the computing device or can be used by a gateway computing device to generate the set of authentication data for the computing device.

In some implementations, the first cryptographic operating mode of the computing device involves generating a public key according to a first cryptographic mechanism. The second cryptographic operating mode generates the public key according to a second cryptographic mechanism that offers stronger security guarantees than the first mechanism.

In some implementations, the first cryptographic mechanism involves a first elliptic-curve cryptographic mechanism using a first elliptic curve group. The second cryptographic mechanism employs a second elliptic-curve cryptographic mechanism using a second elliptic curve group with stronger security guarantees than the first elliptic curve group.

In some implementations, the first cryptographic operating mode of the computing device involves generating a public key using an asymmetric private key and transmitting this public key to a gateway computing device for encrypting data. The second cryptographic operating mode involves transmitting a symmetric key to the gateway computing device for the same purpose.

In some implementations, the computing device is configured to switch operationally from the first cryptographic operating mode to the second cryptographic operating mode in response to receiving a mode control instruction signed by an authority.

In some implementations, the computing device is configured to switch automatically and periodically from the first cryptographic operating mode to the second cryptographic operating mode.

In some implementations, the computing device is a beacon device configured to transmit data using a Bluetooth Low Energy protocol.

An embodiment of a computer-implemented method for providing improved Transport Layer Security (TLS) for communications between a first computing device and a second computing device includes the steps of a gateway computing device receiving one or more first communications from the first computing device. These communications are structured according to the TLS protocol and contain a payload and a client finished portion. The gateway computing device uses the client finished portion as authentication data to establish an encrypted communication session with the second computing device. The gateway device then transmits at least the payload from the first communications to the second computing device within the encrypted communication session.

In some implementations, the gateway computing device uses the client finished portion of the first communications as authentication data by generating a one-way function of this client finished portion. The gateway device transmits this one-way function to the second computing device and subsequently receives a cryptographic key from the second device in response to its authentication of the one-way function.

In some implementations, the gateway computing device transmits at least the payload from the first communications to the second computing device within the encrypted communication session by first encrypting the payload using the cryptographic key to generate encrypted data and then transmitting this encrypted data to the second device.

In some implementations, the first computing device is a client computing device, and the second computing device is a server computing device.

In some implementations, the payload from the first communications includes first encrypted data encrypted by the first computing device according to a first encryption scheme. The gateway computing device further encrypts this payload using the cryptographic key to generate second encrypted data.

In some implementations, the cryptographic key used by the gateway computing device is a random Diffie-Hellman ephemeral public key generated by the second computing device using an elliptic curve group.

An embodiment of a gateway computing device is configured to provide improved security for communications between a first computing device and a second computing device. The gateway computing device is configured to perform various operations, including receiving one or more sets of first encrypted data from the first computing device intended for the second computing device. These sets of first encrypted data are structured according to a secure message transmission protocol and have been encrypted by the first computing device using a first set of cryptographic key material established for a first encrypted communications session between the first and second computing devices. The gateway device engages in key exchange communications with the second computing device, structured according to the secure message transmission protocol, to establish a second set of cryptographic key material for a second encrypted communications session between the gateway and second computing devices. The gateway device further encrypts the first encrypted data using the second set of cryptographic key material to generate second encrypted data and transmits this to the second computing device.

In some implementations, the secure message transmission protocol employed by the gateway computing device comprises a Transport Layer Security (TLS) protocol.

In some implementations, the secure message transmission protocol utilized by the gateway computing device is an end-to-end encrypted protocol.

In some implementations, the operations of the gateway computing device further include relaying initial key exchange communications between the first and second computing devices prior to receiving the first encrypted data from the first computing device. These initial communications are structured according to the secure message transmission protocol and establish the first set of cryptographic key material for the first encrypted communications session.

In some implementations, the operations of the gateway computing device also include advertising a willingness to engage in key exchange communications with the second computing device prior to the actual engagement in these communications.

An embodiment of a method for modifying a cryptographic communication system comprising at least a first, second, and third computing device involves detecting that the first computing device employs cryptographic tools that do not meet certain security constraints and is incapable of being updated with new cryptographic tools that do meet these constraints. In response to this detection, the method includes causing the second computing device to switch from a first cryptographic operating mode to a second cryptographic operating mode. In this second mode, the second computing device uses cryptographic tools that satisfy the security constraints when communicating with the third computing device, thereby limiting the failure to meet the security constraints to communications between the first and second computing devices.

What is claimed is:

1. A gateway computing device configured to perform operations, the operations comprising:
sending to a receiver computing device a first communication, wherein the first communication comprises an identifier associated with a transmitter device, a one-way function of the identifier associated with the transmitter device, or a set of authentication data associated with the transmitter device;
receiving from the receiver computing device a second communication that is responsive to the first communication, wherein the second communication comprises a set of cryptographic material;
authenticating the set of cryptographic material using the set of authentication data; and
sending to the receiver computing device a third communication, wherein at least an encrypted portion of the third communication is encrypted using the set of cryptographic material.

2. The gateway computing device of claim 1, wherein the transmitter computing device comprises a beacon computing device that is incapable of being updated, and wherein the gateway computing device and the receiver computing device have been re-configured after deployment to enable transmission of the first, second, and third communications.

3. The gateway computing device of claim 1, wherein the operations further comprise, prior to sending the first communication, receiving an initial communication from the transmitter computing device that comprises an encrypted message generated by the transmitter computing device, and wherein the encrypted portion of the third communication comprises the encrypted message that has been further encrypted using the set of cryptographic material.

4. The gateway computing device of claim 1, wherein the encrypted portion of the third communication comprises a location of the gateway computing device that has been encrypted using the set of cryptographic material.

5. The gateway computing device of claim 1, wherein the second communication comprises a Message Authentication Code (MAC) value generated from both (1) the set of authentication data and (2) the set of cryptographic material, and wherein authenticating the set of cryptographic material comprises confirming the MAC value.

6. The gateway computing device of claim 1, wherein the set of authentication data comprises the one-way function of the identifier.

7. The gateway computing device of claim 1, wherein the identifier was generated by the transmitter computing device using a first cryptographic key, and wherein the set of authentication data was generated using a second, different cryptographic key.

8. The gateway computing device of claim 7, wherein the set of authentication data was generated by the transmitter computing device and included in an initial communication received by the gateway computing device from the transmitter computing device.

9. The gateway computing device of claim 1, wherein the first communication contains the identifier or the hash of the identifier but not the set of authentication data, wherein the second communication comprises the set of cryptographic key material with a digital signature generated using the set of authentication data, and wherein authenticating the set of cryptographic material comprises confirming the digital signature.

10. The gateway computing device of claim 1, wherein the set of cryptographic material has been received from an owner computing device associated with the transmitter computing device.

11. A computer-implemented method for providing improved Transport Layer Security (TLS) for communications between a first computing device and a second computing device, the method comprising:
receiving, by a gateway computing device, one or more first communications from the first computing device, wherein the one or more first communications are structured according to a TLS protocol and include a payload and a client finished portion;
using, by the gateway computing device, the client finished portion of the one or more first communications as authentication data to establish an encrypted communication session with the second computing device; and
transmitting, by the gateway computing device, at least the payload from the one or more first communications to the second computing device in the encrypted communication session.

12. The computer-implemented method of claim 11, wherein using, by the gateway computing device, the client finished portion of the one or more first communications as authentication data to establish the encrypted communication session with the second computing device comprises:
generating, by the gateway computing device, a one-way function of the client finished portion of the one or more first communications;
transmitting, by the gateway computing device, the one-way function of the client finished portion of the one or more first communications to the second computing device; and
receiving, by the gateway computing device, a cryptographic key from the second computing device in response to authentication by the second computing device of the one-way function of the client finished portion of the one or more first communications.

13. The computer-implemented method of claim 11, wherein transmitting, by the gateway computing device, at least the payload from the one or more first communications to the second computing device in the encrypted communication session comprises:
encrypting, by the gateway computing device, at least the payload from the one or more first communications using the cryptographic key to generate encrypted data; and
transmitting, by the gateway computing device, the encrypted data to the second computing device.

14. The computer-implemented method of claim 11, wherein the first computing device comprises a client computing device and the second computing device comprises a server computing device.

15. The computer-implemented method of claim 11, wherein:
at least the payload from the one or more first communications comprises first encrypted data that has been encrypted by the first computing device according to a first encryption scheme; and
encrypting, by the gateway computing device, at least the payload from the one or more first communications using the cryptographic key comprises further encrypting, by the gateway computing device the first encrypted data using the cryptographic key to generate second encrypted data.

16. The computer-implemented method of claim 11, wherein the cryptographic key comprises a random Diffie-Hellman ephemeral public key generated by the second computing device using an elliptic curve group.

17. A gateway computing device configured to provide improved security for communications between a first computing device and a second computing device, the gateway computing device configured to perform operations, the operations comprising:
receiving, by the gateway computing device from the first computing device, one or more sets of first encrypted data intended for the second computing device, wherein the one or more sets of first encrypted data are structured according to a secure message transmission protocol and have been encrypted by the first computing device according to a first set of cryptographic key material established for a first encrypted communications session defined between the first computing device and the second computing device;
engaging, by the gateway computing device, in one or more key exchange communications with the second computing device, wherein the one or more key exchange communications are structured according to the secure message transmission protocol and establish a second set of cryptographic key material for a second encrypted communications session defined between the gateway computing device and the second computing device;
further encrypting, by the gateway computing device, the one or more sets of first encrypted data using the second set of cryptographic key material established for the second encrypted communications session to generate one or more sets of second encrypted data; and
transmitting, by the gateway computing device, the one or more sets of second encrypted data to the second computing device.

18. The gateway computing device of claim 17, wherein the secure message transmission protocol comprises a Transport Layer Security (TLS) protocol.

19. The gateway computing device of claim 17, wherein the secure message transmission protocol comprises an end-to-end encrypted protocol.

20. The gateway computing device of claim 17, wherein the operations further comprise, prior to receiving, by the gateway computing device from the first computing device, the one or more sets of first encrypted data:
relaying, by the gateway computing device, one or more initial key exchange communications between the first computing device and the second computing device, wherein the one or more initial key exchange communications are structured according to the secure message transmission protocol and establish the first set of cryptographic key material for the first encrypted communications session defined between the first computing device and the second computing device.

21. The gateway computing device of claim 17, wherein the operations further comprise, prior to engaging, by the gateway computing device, in the one or more key exchange communications with the second computing device:
advertising, by the gateway computing device, a willingness to engage in the one or more key exchange communications with the second computing device.
